(19) United States
(12) Patent Application Publication
(10) Pub. No.: US 2017/0030552 A1
(43) Pub. Date: Feb. 2, 2017

(54) Method and means to evenly distribute ambient illumination and to avoid bright LED beam directly into human eyes

(71) Applicant: Sergio Lara Pereira Monteiro, Los Angeles, CA (US)

(72) Inventor: Sergio Lara Pereira Monteiro, Los Angeles, CA (US)

(21) Appl. No.: 14/937,874

(22) Filed: Nov. 11, 2015

Related U.S. Application Data
(60) Provisional application No. 62/197,843, filed on Jul. 28, 2015.
(60) Provisional application No. 62/206,935, filed on Aug. 19, 2015.

(51) Int. Cl. F21V 7/00; H05B 37/02; H05B 33/08; F21V 11/06; F21K 99/00

(52) U.S. Cl. CPC F21V 7/0008; F21V 11/06; F21K 9/58; H05B 33/0845; H05B 37/0272

(57) ABSTRACT

An energy-saving LED-based device with improved support structure for high-brightness LED chips for room illumination. The improved support structure positions the LED chips in such a way that the light is emitted towards the ceiling, the floor, or any other surface, along such a path that human eyes are unlikely to cross the light path. Because the bright light is kept away from people's eyes, there is no need for shades, which absorbs some of the light produced. Two of the most common shades are the light breakers surrounding the standing lamps in residential spaces and the light breakers around the lights near the ceiling that are part of the indirect lighting. Dispensing with the shades increases the overall energy efficiency because the light energy absorption by the shade is obviated. The illumination created by such improved LED arrangement is also more pleasing to humans because it creates less shadows.

### CROSS-REFERENCE TO RELATED APPLICATIONS

This application is a utility patent application based on a previously filed U.S. Provisional Patent Application Ser. No. 62/197,843 filed on 2015 Jul. 28, entitled “Method and means to avoid bright LED beam for ambient illumination directly into human eyes”, and U.S. Provisional Patent Application Ser. No. 62/206,935, filed on 2015 Aug. 19, entitled “Method and means to decrease the visibility of lines and other image artifacts on LED billboards and other illuminated displays and to control the direction of light emitted by individual LEDs”, the benefit of which is hereby claimed under 35 U.S.C. par. 119(c) and incorporated herein by reference in its entirety.

### FEDERALLY SPONSORED RESEARCH

Not applicable

### SEQUENCE LISTING OR PROGRAM

Not applicable

### BACKGROUND OF THE INVENTION

Field of Invention

This invention relates to the field of light and energy efficiency, of providing more illumination for unit of used electric energy. This invention also relates to the field of room luminaires and space illumination in general, specifically to LED luminaires.

Discussion of Prior Art

We start this section with the definition of the most important terms we use, in order to comply with the USPTO requirement of the use of “exact terms” and also for not to leave room for misunderstandings of the meaning of our words as used in this document. Firstly here we specify some key terms we use, then some of the abbreviations used in the figures, with their precise definition too.

Diffuse reflection also known as non-specular reflection is the reflection on a surface such that incident light is reflected to all directions, though not necessarily isotropically. Most white walls are diffuse reflectors. Also, in our use here, the definition generally does not imply perfect diffusiveness, but is acceptable when the reflection is more-or-less diffuse, that is, when there is preferential reflection towards some angles, as long as this anisotropy is small. cf. with specular reflection. (see FIG. 1)

Divergence angle—when applied to a directed light emitting device, divergence angle measures the angle which encompass the majority of the photons emitted by the source. Following general practice, we here use “majority of” meaning 1/e=˜1/2.7182818=˜0.36788=approx 37% of the total light energy emitted within a cone with apex angle equal to the divergence angle, with the light source at the apex.

E26-E27 There is a lot of confusion about the use of these names, and no agreement on their meaning. Therefore we here define only our meaning of the words used according to the best we could have determined to be the use by most people. E26 is the technical name of the American standard household incandescent light bulb socket, which seems to mean 26 mm, which is said to be 1 inch. In reality 1 inch is 2.54 mm, which would be approximated to 2.5 mm not to 2.6 mm. We do not know the history, etc of this. It appears that E26 is the standard adopted in US, Canada, Central and South America (excluding Brazil), Japan and Taiwan. E27 is the similar standard used in Europe and most of the world, and it seems that it stands for 27 mm. These bulbs are more-or-less interchangeable, because the difference is small and there are a few threads only. We will be using the name E27 because it is the standard adopted in most of the world, while it will be understood that what is stated for E27 applies equally well to E26. It appears that E stands for Edison (Thomas Alva Edison). (cf. Edison screw)

Edison screw. Name of the mechanical/electrical standard for the screw base used for the common incandescent light bulb which is the almost universal light producing device in US. Europe uses an almost equal size, with same pitch but 1 mm wider. (cf. E26-E27)

Electromagnetic wave. Any of the oscillations of an electric field and a magnetic field described by Maxwell's equations, which include as a special case the visible light but also many other types, as gamma rays, ultraviolet light, infrared light, microwave, radio waves and more.

Iluminance is defined as the total luminous flux (q.v.) incident on a surface, per unit area. It therefore measures the amount of incident light that illuminates the surface corrected by the luminosity function that measures the physiological perception of light as detected by the human light detectors (cones and rods). By “corrected” we mean that light of longer wavelengths, say, λ=690 nm, a deep red, near the edge of detection by human eyes, is detected with an 8% relative efficiency (relative here means compared with the efficiency of the detection system of a human at the green λ=555 nm, which it the maximum efficiency for humans) then the electromagnetic energy at this wavelength is multiplied by 0.08 (8%) to account for this small efficiency of detection at its wavelength. The limiting case of the correction is the case of electromagnetic waves outside the visible window, say, infrared and ultraviolet, in which case the multiplying factor is 0 (zero), because these electromagnetic waves are not detected by the human eye. The correction is applied at the luminous flux step. (cf. luminance and luminous flux).

LED. Abbreviation of Light Emitting Diode. The name is misleading because there are LEDs that emit in other regions of the electromagnetic spectrum beyond the visible, as the ultraviolet and infrared. When we use the term LED we mean the general use of the term, meaning any wavelength produced by LEDs, visible and beyond, and when we refer to LED light we are also simply using the established practice of using light as a synonym of any electromagnetic radiation produced by the LED. This is a common practice, also used in LASERs, which is an abbreviation of Light Amplification by Stimulated Emission of Radiation, but there are LASERs emitting radiation from the X-ray, through the ultraviolet, the visible, the infrared to the micro-wave parts of the electromagnetic spectrum.

LED chips Light Emitting Diode chip, is the name of our creation for the small, typically 2 mm by 2 mm elements that emit light. The chips can be easily seen in most of the clear window LED emitters. These are not chips in the standard use of integrated circuits, but only in the sense of being semiconductor devices (diodes). The name is misleading, because there are LEDs emitting ultra-violet and infra-red electromagnetic radiation, so light in the name should be understood as electromagnetic radiation instead of visible light, a left-over from the initial LEDs, when they were only capable of producing visible light The 2 by 2 mm2 is just typical dimension, the actual size of any particular one may be different.

Louver is a (generally small) protrusion used for controlling the light propagation, generally to block light propagation along some direction or directions.

Luminance of a light emitting surface is defined as the quantity of visible light emitted per unit of surface area of the emitting surface, along a specific direction, as detected by an average H. sapiens. This last proviso means that the luminance value is weighted by the relative or perceived brightness to a person. It is measured in candela per square meters (cd/m**2). It therefore measures the amount of emitted visible light from a specific projected area that propagates along a specific direction. (cf. iluminance and luminous flux)

Luminous flux (also known as luminous power, which is a more intuitive name but which I will not use here because it is less used than luminous flux) is defined as the measure of the perceived power of light as detected by an average fictitious human being. We are here using power in its scientific meaning of energy per unit time. In practical terms this means that the actual electromagnetic energy is multiplied by a factor that measures the relative sensitivity of the human eyes detectors for each wavelength (color) of light. This factor is 1 (one) at the maximum efficiency of the human eye near the green (λ=555 nm, but there is a difference between the photopic and scotopic cases which we leave aside here), decreasing to 0 (zero) at the borders with the infrared and ultra-violet, both of which are invisible to human eyes. Note that even at the maximum efficiency not all photons are detected by the human rods and cones, and the factor is 1 only because it is a relative (not absolute) correction factor. (cf. iluminance and luminance)

Normal incidence is defined in optics and geometry as perpendicular incidence. By convention all angles in optics are measured from the normal, so normal incidence in optics is 0 dgs. (zero degrees).

Shade vs. shadow. These two terms will be used in the text and we use them in the standard way. We define them here not because we are using these words in any unusual way, but only because they are similar yet their place in the understanding of our invention is crucial. For us here “shade” means the cover (the physical object) often used around some light sources, which scatters the light source inside, causing that the full (larger) surface of the shade becomes the origin of the light for the external part of it. Our use of the word “shade” is the physical object often made from thin fabric or paper or frosty glass that often surrounds a lamp inside. “Shadow” means a region of smaller illumination then the surrounding regions, particularly if with a sharp transition in iluminance which results from an opaque object blocking light from reaching the area of the shadow.

Specular reflection is the reflection on a surface such that light incident on the surface at a particular angle θi with the normal is reflected at the angle θr which is equal to θi, but towards the opposite side of the normal. Mirrors are specular reflectors. (see FIG. 1) (cf. Diffuse reflection).

Some of the abbreviations used in the figures:

E-arm=Extendable arm used to swivel the supporting surface hem1 for redirecting the emitted light.

hem1=stands for hemsphere1, the shape of the main LED chip supporting surface. We will use the term in a more generalized way, even if the supporting surface is not a true hemisphere, so, in the context of this patent disclosure hem1 stands for the structure that supports the LED chips.

supp1=stands for support1, the main supporting structure that also makes all the required electrical connections. There are several possible forms of supp1, each corresponding to one of the existing mechanical/electrical standards. Examples of supp1 are the Edison-screw (E26 and E27) standards for the incandescent bulbs used for home light in US, the long fluorescent tubular used mostly in offices, educational institutions and businesses, the smaller halogen bulbs much in use in Europe, etc.

The electric light bulb was invented by Humphry Davy in 1801-1802, before Thomas Alva Edison was even born. In the intervening years a large number of scientists, engineers and inventors worked on the problem, which was known to be a technologically important one. Examples are James Bowman Lindsay, Warren de la Rue, Frederick DeMoleyns (all British and Scottish), the Russian engineer Alexandr Lodygin, who got a Russian patent in 1874, and the British Sir Joseph Wilson Swan who designed, built, demonstrated in public lectures and used in his home and public buildings lamps that were virtually the same as Thomas Edison's invention.

We have not been able to ascertain if the glass enclosure of Sir Joseph's first light bulb was transparent or frosty (milky, highly scattering), but we much suspect that it was a transparent glass. The glass type used by Sir Joseph (clear or frost) has much to do with our invention, as it will be seen further down in the specifications, because our invention has to do with increasing the area from which the illumination spreads into the space, as in indirect illumination. Though it is generally asserted that Sir Joseph's light bulb suffered from a short life due to the poor vacuum he was able to get at the time, we are not convinced of the truth of this, largely because vacuum pumps have been used for more than 200 years by the time Sir Joseph did his work on the light bulbs.

Some 20 years after Sir Joseph's first light bulb, Thomas Alva Edison “discovered” it again, making another light bulb, also using a carbon filament and also using an evacuated enclosure to avoid oxidation of the carbon filament, everything exactly the same as Sir Joseph's earlier work. Thomas Edison stated that the carbon filament was kept “ . . . in a nearly perfect vacuum, to prevent oxidation and injury to the conductor by the atmosphere.”

Thomas Alva Edison was a good salesman and had no inner objections to pretend to have invented things. For example, when he installed light bulbs in the steamship Columbia it appears that he pretended to have been the inventor of the light bulb. Like the incandescent bulbs still in use in US (incandescent light bulbs are hardly used in the industrialized world anymore) the filament was inside a glass enclosure which allowed the light to escape while keeping the filament in an environment deprived of oxygen, to forestall the filament oxidation. These lamps were considered a marvel, and marvel they were when compared with their predecessors: the candle, the oil lamp and the gas light. Sometime later the clear glass bulb became frosted glass, a feature that has much to do with our invention, because with the clear glass bulb the source of all light was the small filament, causing a very bright source (high luminance), while the frosted glass bulb had virtually the same luminous flux (same light energy) but the luminance (light per unit area) was much smaller because the area of the origination of the light energy was the much larger area of the frosted glass, which in turn makes the source easier on the eyes of people around it and less pronounced shadows as well. This larger area for origination of the light energy caused (1) less discomfort in humans if their line of sight crossed the light source, and (2) less shadows, because with illumination originating from a larger area each object in the room received light from multiple directions. This has to do with our invention, as seen in the disclosure below, because one of the goals of a good illuminating device is to have diffuse light (originating from many points at once, from as large an area as possible), because this causes less shadows and also because it has smaller luminance (less bright).

The figures at the published patents do not really allow one to be sure about the transparency of the glass enclosure of Thomas Edison's first light bulb, but both the patent figure and text, and other indicators as well, point to the glass being near transparent, as a standard household window glass and as some incandescent light bulb available in US still are—but note that the glass of most light bulbs seen in US are now frosted, or milky, to increase the surface area of the light emitter. The inventor suspect, both from general knowledge and from other pictures from other old lamps, that the carbon filament of these earlier lamps evaporated and deposited on the inner side or the glass enclosure, causing that they became progressively darker, with decreasing illumination.

In anticipation to the description of our invention, the inventor saw in Wikipedia a back-reflector for fluorescent lights that indicates that the luminaire engineers are aware of the advantage of emitting light only towards the space that is to be illuminated. FIGS. 2a and 2b are modified versions of the Wiki figure, including the emitting atoms, the reflecting coating at the lamp's lower half and the re-emitting fluorescent coating at the lamp's upper internal surface. FIG. 2a is an axial view of a current fluorescent tube, which emits light to all directions, and FIG. 2b is an axial view of a fluorescent tube with its lower half made reflective, so FIG. 2b shows a fluorescent tube that emits light towards one side only of the tube. The inventor has not seen any such fluorescent light tube other than in Wiki. It is interesting to see that the advantage of having illumination only towards the desired space is known. This case shows that the problem solved by our invention is a known problem that has resisted solution in the past, yet has not been addressed by the engineers involved in the design of the new LEDs. So, not only is our solution more energy efficient than what was possible with gas tubular lamps, but the LED lamp designers failed to see how to adapt a new design to a previously recognized problem—which is a factor for the concession of the patent we are now applying for.

Regarding the luminance (light energy per unit area of emitter), Wikipedia has this to say about the fluorescents compared with the incandescent bulbs: “Compared with an incandescent lamp, a fluorescent tube is a more diffuse and physically larger light source. In suitably designed lamps, light can be more evenly distributed without point source of glare such as seen from an undiffused incandescent filament; the lamp is large compared to the typical distance between lamp and illuminated surfaces.” We will come back to this point when discussing the advantage introduced by our invention, but we want to use this to show that it is well known that there is an advantage of having as large as possible a surface area from which the light spreads through the space, which is one of the advantages of our invention.

### OBJECTS AND ADVANTAGES

Accordingly, one object and advantage of our amazing invention is to make redundant the lamp shades that are designed to prevent too bright a light to hit the eyes of people in the room, which have the deleterious side effect of absorbing light too, therefore decreasing the energy efficiency of the system by 10% and more, depending on the actual material used for the shade.

Another object and advantage of my invention is to avoid the light absorption caused by the light shades, therefore increasing the overall energy efficiency of the light elements, because more of the light produced is available for illumination. The light shades are used for scattering but there is a secondary effect of absorption too, which decreases energy efficiency.

Another object and advantage of my invention is to provide a more evenly distributed illumination in the room, because our invention causes that most of the light energy suffers the first scattering event from a much larger area, therefore increasing the distribution of the energy in point of origination and in direction. A more evenly distributed illumination has a secondary effect of diminishing shadows—because the objects are illuminated from many sides at the once.

If one or more of the cited objectives is not achieved in a particular case, any one of the remaining objectives should be considered enough for the patent disclosure to stand, as these objectives are independent of each other.

### SUMMARY OF THE INVENTION

A number of LED-based luminaires have been produced recently as part of the general drive to decrease energy use—LEDs are the most energy efficient light producing device available today. This happens because LED-based light is at least and usually more than one order of magnitude (10 times) more energy efficient than old-style incandescent light bulbs (the actual number depends on several factors, so there is no hard number to express the relative efficiency). This energy efficiency is a direct consequence of the physics involved: black-body radiation for incandescents versus energy band gap for LED semiconductors. Nevertheless, little attention has been devoted to factors that are also involved in energy efficiency beyond the physics of the devices, and our invention relates to one of these secondary effects: the desirability of increasing the surface area from which space light is distributed in the space to be illuminated. This goal of increasing the area from which light is injected in the room, is necessary to protect human eyes from an unpleasantly bright light source (just go home and take away the cylindrical shade that surrounds an incandescent lamp at eye level to see the truth of this statement).

Accordingly, the invention discloses specific positions and directions to place the small LED chips, to take advantage of the directionality of the light emitted by the LEDs for a better evenly spread space illumination and for improving energy efficiency. We repeat here that the energy efficiency originating from our invention stems from the elimination of the shades surrounding the light sources, which are source of light absorption. Our invention does not produce more light per unit of energy used by any LED, but rather our invention obviates the need for the common shades, which then eliminates a source of light loss with the same final objective of improving energy efficiency.

To put these savings in perspective, a 10% energy savings, which is a low figure for the energy absorption by the shades, may seem insignificant, but according to the US Department of Energy on its January 2012 publication “Energy Savings Potential of Solid-State Lighting in General Illumination Applications” (http://apps1.eere.energy.gov/buildings/publications/pdfs/ssl/ssl_energy-savings-report_jan-2012.pdf), page 9, the expected total energy savings in 2030 and in US alone, due to the substitution of the projected 74% of current light producing mix for LEDs will be “ . . . 300 terawatt-hours, or the equivalent annual electrical output of about fifty 1,000-megawatt power plants. At today's energy prices, that would equate to approximately $30 billion in energy savings in 2030 alone. Assuming the current mix of generating power stations, these energy savings would reduce greenhouse gas emissions by 210 million metric tons of carbon. The total electricity consumption for lighting would decrease by roughly 46 percent relative to a scenario with no additional penetration of LED lighting in the market—enough electricity to completely power nearly 24 million homes in the U.S. today”. So, 10% of these savings means 50/10=five 1,000-megawatt power plants that will not be built and operated with the adoption of this invention To put this into perspective, the Grand Coulee Dam generates 6,800 MW and Hoover Dam generates 2,100 MW, so the savings from my invention, even using a conservative 10% absorption from the shade is almost equivalent to the Grand Coulee Dam, or equivalent to 2½ Hoover Dams, not bad! As for money, $30 b/10=$3 billion savings per year for the whole U.S., not a trivial amount by any means. Regarding “ . . . completely power nearly 24 million homes in the U.S. today”, at the conservative figure of 3 persons per household this means 72 million persons total, 10% of which is 72 m/10=7 million persons, or the total population of Washington state to have all their lighting needs for free. So, the conservative 10% savings for the elimination of the shades covering light sources is a humongous energy savings.

LED luminaires have been introduced in a world already committed to either the E27 incandescent bulb, also known as Edison-screw bulb, which dominates the home sector, or to the tubular fluorescent lights, which dominates the industrial/commercial/office/educational sector. There are other standards in place, with smaller penetration, which we will barely mention, only because of their smaller commercial importance, but our invention applies to all the technologies, as it will become apparent.

Given the existing committed hardware in place, the newcomers LEDs have little choice other than occupy the existing installed hardware niche, with luminaires that are interchangeable with one of the existing standards, that are plug-compatible with the existing hardware. Accordingly there are LED-based luminaires that can be screwed into the E27 Edison-screw hardware used in home lighting, LED-based luminaires that can be inserted into the long fluorescent tubular lights used mostly in businesses/commercial establishments, and other existing standards as well. We will use the E27, Edison-screw for our main embodiment, but the principle disclosed on our main embodiment can easily be adapted to other standards, so we will mention a few other modifications for the second technology of fluorescent lights, and also a few examples of adaptation to other technologies too.

One of the most distinguishing characteristics of the LEDs luminaires is that they emit light on a fairly small angular aperture—not milliradians as most lasers do, but still a very small angular aperture. It is worth to point out here, for the benefit of the readers with less technical training, that the angular aperture of the LEDs is nevertheless large enough that these devices pose no danger to the eyes—as most lasers do, but it is simply that LEDs are way too bright for comfort for looking directly into them even if they are as low as a few 10 s mW of electrical power. This small angular aperture, in turn, cause that unless the LEDs are extremely dim, e.g., the turn-on light indicators on electronics panels, nobody likes to look directly at them. In reality the inventor have seen a few electronics panel indicators with LEDs that are uncomfortable to look at from a straight line with their direction. We suggest that our reader try this; most panel LEDs are too dim to be uncomfortable, but occasionally the reader will bump into one that is uncomfortable to look at, and panel indicators LEDs are on the mW power range only.

There has been no time to ponder about the differences between the old light emitting technologies that emitted light on all directions (isotropically) and the new LED-based substitutes that emit light on a narrow cone. We believe that one of the reasons of this is the fast introduction of these more energy efficient substitutes, Our invention makes use of the directionality of the LED-based substitutes for the incandescent and fluorescents and others to achieve a better spread illumination. Our invention also protects humans in the surrounding space from the inconvenience of bright light beams at the same time that it makes the former protective shades redundant, thereby increasing the overall energy efficiency of the LED luminaires. This increase in efficiency occurs because the shades also absorb light, so retiring them leave more light available.

### BRIEF DESCRIPTION OF THE DRAWINGS

FIG. 1—Definition of the quantities for specular and diffuse reflection.

FIG. 2a—Ordinary fluorescent lamp—axial view.

FIG. 2b—Fluorescent tube lamp with reflecting surface—axial view.

FIG. 3a—Light on all directions from incandescent bulb—Uncomfortably bright on eyes—“Too bright, I don't like”+unhappy face

FIG. 3b—Incandescent bulb with frosty glass spherical scatterer is too bright but acceptable.

FIG. 3c—LED luminaire of our invention spare the eyes of people in the room from too bright light—happy face.

FIG. 3d—LED luminaire of our invention including louver. No bright light on eyes—smiley face

FIG. 3e—A perspective view of the main embodiment of the invention, which has hemispherical back-emitting LEDs emitting light only near above the horizontal. This main embodiment is good for a vertically mounted incandescent E27 (Edison screw) light bulb substitute attached to the ceiling.

FIG. 3f—A side view of the main embodiment of our invention, showing only the LEDs at the contour. Suitable as a substitute for vertically mounted facing down incandescent type E27 Edison screw bulbs.

FIG. 4a—An example of current commercialized LED luminaire. The LEDs are sprinkled around the surface of the supporting structure with no consideration for the eyes of people, just assuming that the LED should be an isotropic emitter.

FIG. 4b—another example of current commercialized LED luminaire. The LEDs are sprinkled around the surface of the supporting structure with no consideration for the eyes of people, just assuming that the LED should be an isotropic emitter.

FIG. 5—Fresnel equations for reflectance of parallel (p) and perpendicular (s) polarizations. The standard abbreviations come from the German words because most of this work was done by Germans.

FIG. 6—Graph of the reflection coefficient for the parallel (p) and perpendicular (s) polarizations as described by Fresnel equations.

FIG. 7—Several possible shapes of louvers.

FIG. 8—Sunset (or sunrise) over the ocean. Very bright because of high reflectance due to grazing incidence (see Fresnel reflectance, FIGS. 6 and 7).

FIG. 9—Variation of main embodiment where the surface hem1 is deformed to favor more grazing incidence on the ceiling to increase reflectance.

FIG. 10 (a, b and c)—A possible switch for long-term enabling and disabling of particular LEDs on a luminaire.

FIG. 11 (a, b and c)—Progression from the dinosaur E27 incandescent to our wonderful invention: naked incandescent, lamp with shade and our invention.

FIG. 12—Possible variation on the main embodiment, with LEDs facing forward and backward on an E27 base.

FIG. 13—A variation on FIG. 12, with flat surfaces.

FIG. 14—Another variation on the main embodiment with a rotatable LED supporting surface hem1 that allows illumination along a particular direction chosen by the angular position of hem1.

FIG. 15—One of the existing LEDs for use in E27 base electrical standard.

FIG. 16—Side view (top) and axial view (below) of a possible variation of the main embodiment for use with the tubular fluorescent luminaires. Note that preferably the LEDs are positioned to point upward, to direct light away from the eyes of people.

FIG. 17 (a and b)—Two variations on the shape of the tubular fluorescent replacement with LEDs of our invention.

FIG. 18 (a and b)—Two more variations on the shape of the tubular fluorescent replacement using our invention.

FIG. 19 (a and b)—Another two variations on the shape of the tubular fluorescent replacement using the directed LED chips of our invention.

FIG. 20—Still another variation on the tubular fluorescent replacement of our invention, here with the LEDs pointing to such directions that the emitted light hits the ceiling at a grazing angle of incidence, therefore increasing the reflectivity and maximizing the “energy saving”.

FIG. 21—Horizontally directed E27 incandescent bulb used in indirect lighting near the top corner of the wall, near the ceiling.

FIG. 22—Several shapes of light breakers used for indirect lighting.

FIG. 23—Vertically directed E27 incandescent bulb used in indirect lighting near the top corner of the wall, near the ceiling.

FIGS. 24 (a, b and c)—Progression of improvements on the arrangement shown at FIG. 21 with our invention for indirect lighting: just the LEDs emitting light toward the ceiling, omitting the redundant light breakers, and finally adding LEDs emitting light toward the vertical wall for more indirect illumination.

FIGS. 25 (a, b and c)—Variation on FIG. 24 for vertically mounted E27 in indirect illumination: same as in FIG. 24, just the LEDs emitting light toward the ceiling, omitting the redundant light breakers, and finally adding LEDs emitting light toward the vertical wall for more indirect illumination.

FIGS. 26 (a and b)—Another variation on the main embodiment, with a supporting surface capable of swiveling on a hinge, adjusted by an extendable arm E-arm.

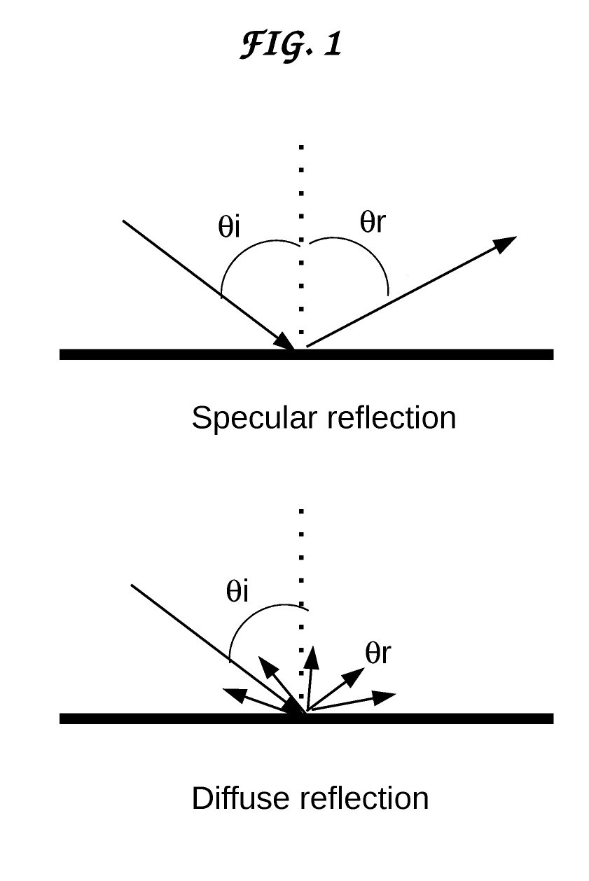

### DETAILED DESCRIPTION

### Preferred Embodiment

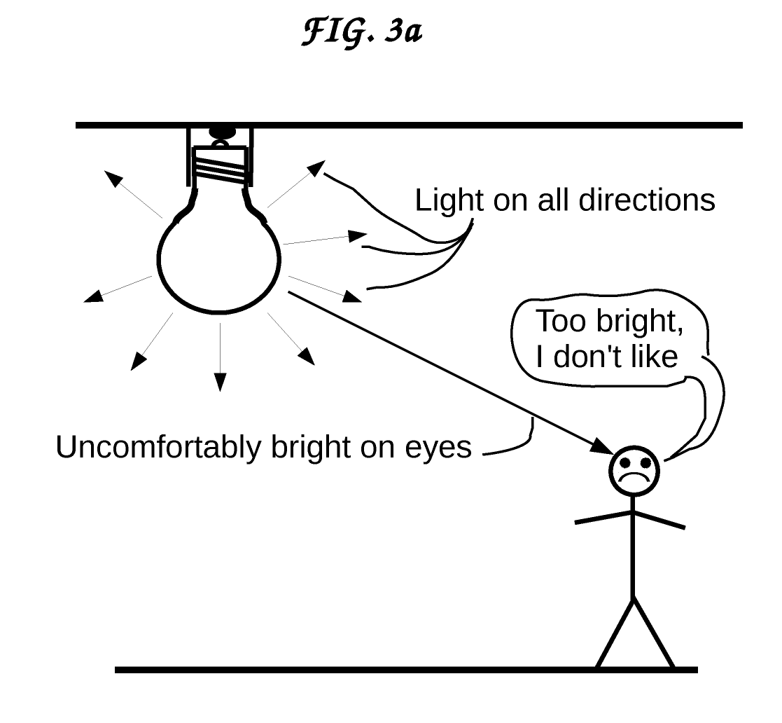

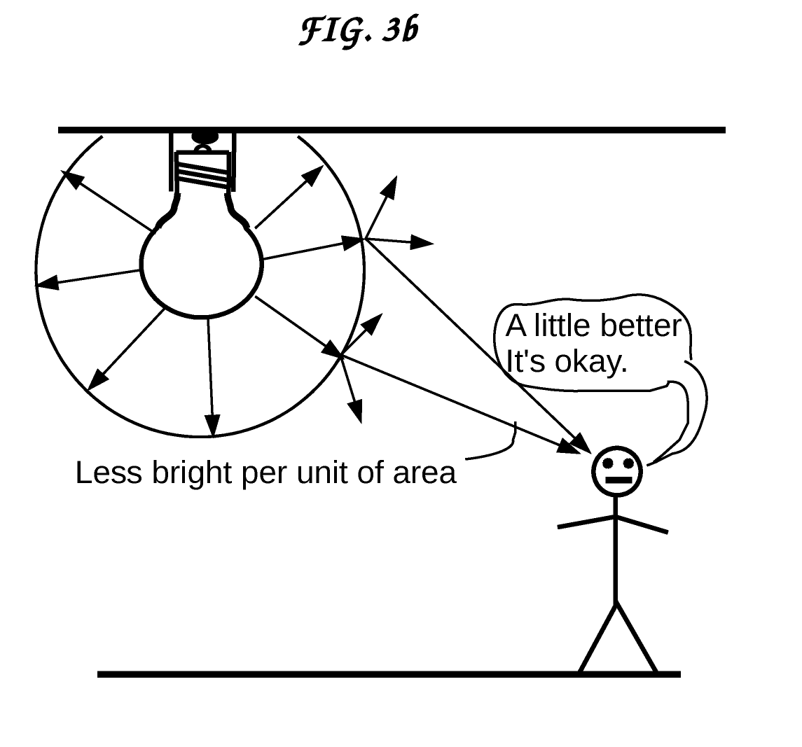

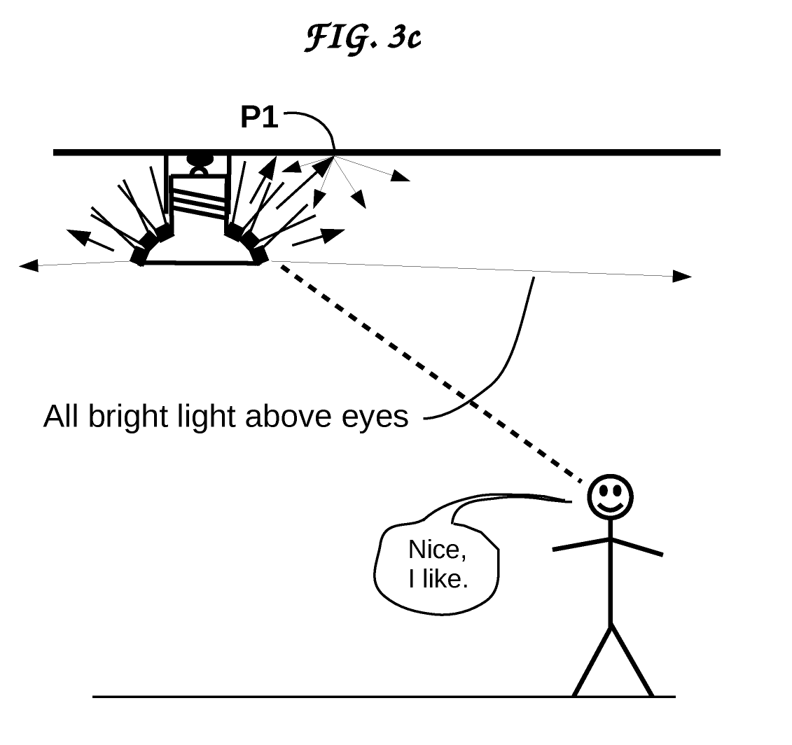

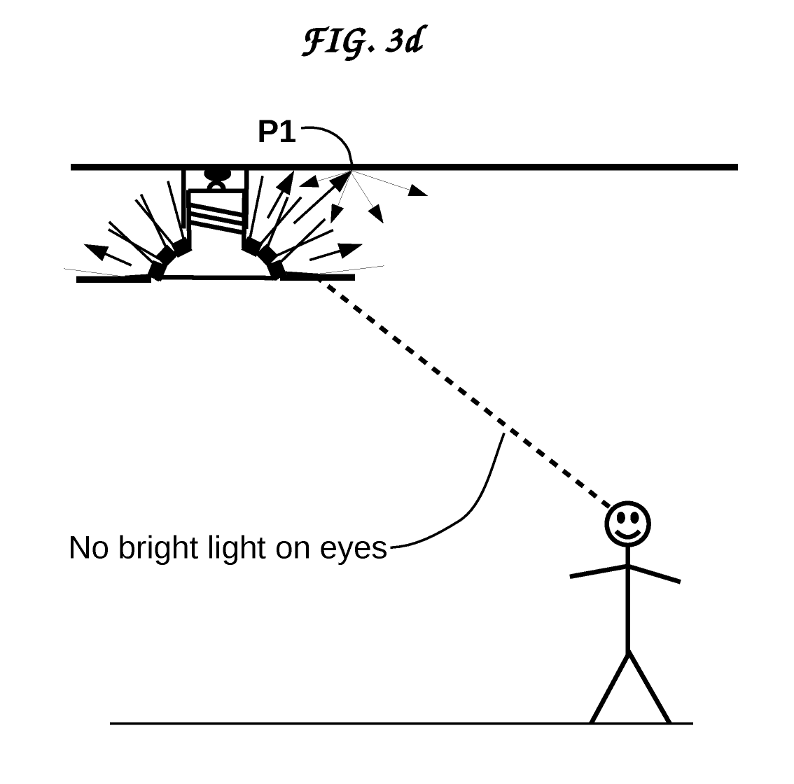

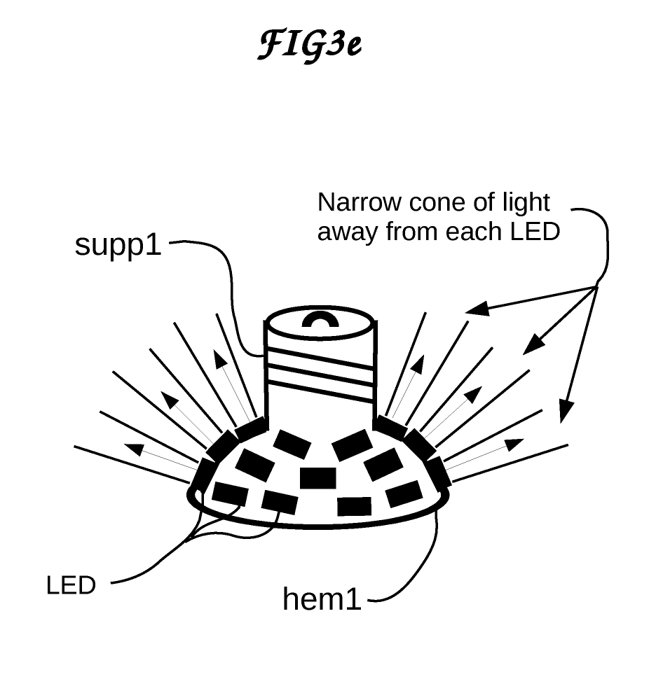

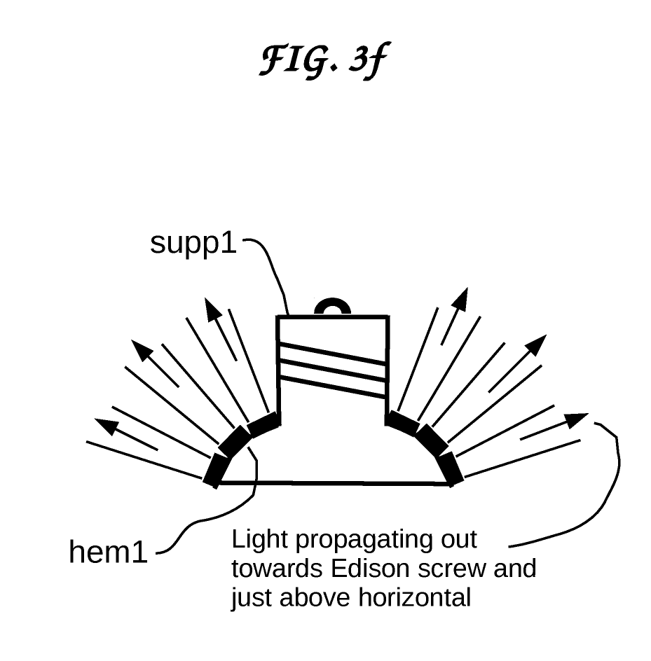

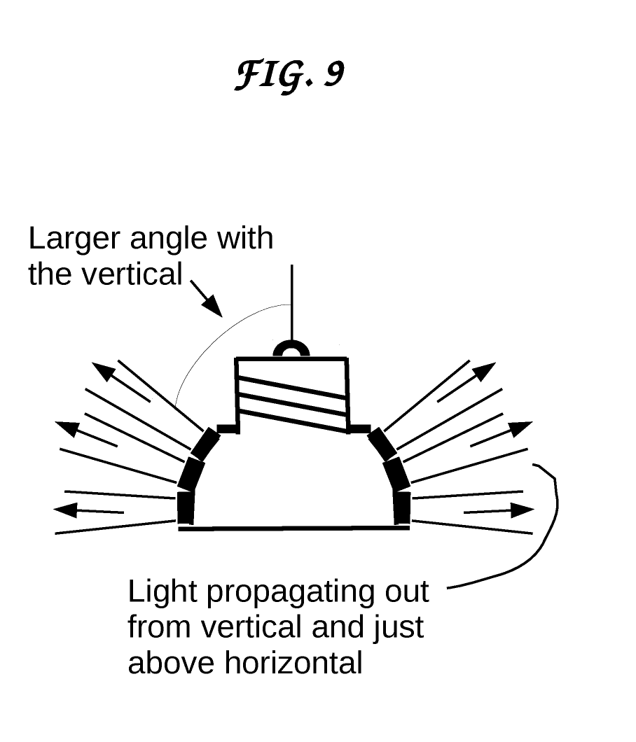

### FIGS. 3 Through 3f and 9

This main embodiment is described for use with the Edison-screw E26-E27 incandescent bulb, but the same principles apply for other standards for light producing devices, as the long tubular fluorescent that dominates the office, school and commercial sectors, or the halogen lights, and others. Glancing quickly at FIGS. 3a, 3b, 3c, and 3d, the reader will get the flavor of this brilliant invention, which offers three entangled advantages: (1) to obviate the need for the frosted glass/plastic larger surrounding container around the incandescent light bulb, which also absorb light and therefore contribute to energy loss (using the accepted language, because, of course that energy is never lost in the scientific meaning of it), (2) to prevent bright lights into the eyes of humans around them, and (3) to better spread the illumination from a larger source, thereby decreasing shadows, because using our invention the light reaching any object in the illuminated area does so receiving light from more directions all at once.

The frosted shades are used because as they scatter the incoming light from the incandescent light bulb inside it, then, after propagating through the thin shade, the light that emerges from the outer surface of the shade is generally isotropically emitted and from a larger surface area than the inside filament surface area. In technical parlance one can say that the luminance of the frosty surrounding shade/container is smaller than the luminance of the incandescent light bulb inside it. It follows that with the addition of the frosty shade, the new light source is easier on the eyes of people around. A side advantage from the larger surface area is less shadows in the room, which is more comfortable for humans. The shades surrounding the incandescent light bulb create less shadows for the same reason of having lower luminance: larger surface area of the shade than the area of the frosted glass envelope of the light bulb, which is larger still than the area of the filament inside. Indeed, each illuminating point in the surface produces its own particular different shadow, and these different shadows average out to a more even, shadowless illumination. This is better for good vision in the space, besides being more pleasant and peaceful for humans. The undesirable problem that comes together with these advantages, which is the reason for the shades to have been introduced, is that frosted shades also absorb light, therefore contributing for energy inefficiencies that are typically on the order of usually more than 10% of the light energy. This inefficiency was not a concern 50 years ago and earlier, nobody thought about the matter then, but today it is different, energy efficiency is now a concern and the elimination of the shades around the light sources would be a welcome improvement. Obviating the shade this invention eliminates a source of energy inefficiency.

Continuing now with the details of our invention, FIGS. 3e and 3f show the main embodiment of our invention. Our invention consists of a body supporting structure supp1, which is hardware compatible with E27, which provides electrical contact and mechanical support to the existing standard of incandescent light bulbs used in most households. Moreover, the main embodiment is designed to be used on E27 vertically mounted on the ceiling, as in FIG. 3c. Other locations and other directions require different hardware, as per disclosure that follows, so the main embodiment is E27 sockets that are vertically mounted on the ceiling pointing down. This supporting structure supp1 in turn provides support for hem1 which holds in position a plurality of LED chips, which, for the main embodiment, is the hemispherical supporting surface hem1 shown in FIGS. 3e (perspective) and 3f (contour view). Support hem1 provides the mechanical and the electrical connections for the LED chips. In the main embodiment, hem1 is a hemisphere, just the upper part of a spherical surface. Attached to hem1 there is a plurality of LED chips, as shown in the figures. Many similar shaped surface would work too, as variations of the hemisphere may be easier to manufacture, or cheaper, or any other advantage, without changing the character of the invention. The geometry of the main embodiment is designed to be attached only to the vertically positioned E27 female receptacle at the ceilings of the majority of homes that use a light source at the ceiling. Due to the hem1 geometry and to the fairly directional light emitting characteristic of the LEDs, the LEDs emit light at angles with the vertical line determined by the axis of screw E27 that vary from a few degrees to less than 90 degrees, say, from 10 degrees to 80 degrees with the vertical, as seen in FIGS. 3e and 3f. We repeat that the axis of screw E27 is the vertical direction only because in this case for the main embodiment: a vertically mounted E27 incandescent bulb substitute as shown in FIG. 3c, which is a common situation in homes. Note that a smaller number of ceiling mounting receptacles receive incandescent light bulbs at a horizontal direction—often the case when the luminaire is designed for two or three incandescent light bulbs; the main embodiment is not supposed to be used on these less common horizontally attached incandescent bulbs, for which there exists a variation of the main embodiment as seen in the sequel! With the LED-substitute vertically mounted, as in FIG. 3c, people in the room are spared from bright light on their eyes, which is not the case of the old incandescent light bulbs as shown in FIG. 3a. This geometry, with the LEDs mounted on the upper part of a hemisphere, the LEDs emit light directed from just above the horizontal direction, towards the upper part of the wall, above people's eyes, to just below the vertical upward direction. This light is then subsequently diffusively scattered from all the illuminated parts of the upper wall and of the ceiling, which becomes affectively a rather large area from which light illuminates the room. In effect this is a new way to create what is known as indirect illumination.

The above disclosure can be seen in the three figures that compare the old style incandescent bulb alone hanging down from a ceiling at FIG. 3a, which shows an unhappy person complaining from the excessive brightness on his/her field of view, with an improved situation at FIG. 3b, where the room illumination is still provided by an old-style incandescent bulb but in this instance covered by a spherically shaped frosted glass enclosure which acts as a scatterer, re-emitting the light produced by the light bulb but from its larger surface area, causing a smaller luminance, then, finally, FIG. 3c depicts the case where the illuminating source is the wonderful light source of our invention, which emits light only towards the ceiling and upper portions of the walls, from where it scatters to all points of the room, therefore causing the best feeling on the smiling human in the room.

### Operation of the Invention

The operation of the invention is based on taking advantage of the small angular divergence of the light emitted by LED emitters, or LED emitting chips, to obviate the need of the shades that are often used surrounding most incandescent bulbs E27 and most other light sources. It is worth to note that the new LED light source is the first light source that can be commercially produced in large numbers and low price which emits light on a small cone. This elimination of the need for a shade surrounding the LED emitter of our invention is achieved with a combination of knowing the position and orientation of the E27 substitute, and pre-arranging the LED chips in such directions that they only emit light towards directions that are unlikely to cross the eyes of any human in the vicinity while performing the normal activities that are expected to occur. Our invention causes that the original beam of LED light is directed to the high parts of the walls and/or to the ceiling, perhaps also to the floor. From these large area targets light is spread through the room in a form similar to what is known as indirect lighting.

A secondary advantage of using the indirect illumination from the larger area of the walls, ceiling and etc. is that since the illumination enters the space from a larger area when compared with the typical surface area of the shades, it follows that our invention provides illumination virtually with no shadow, which is pleasant for people. The situation is equivalent to the marked shadow of a person in direct sunlight compared to the no-shadow situation of the same person under a tree in a bright day; in the former case most of the light on the person comes from the small angular aperture of the sun, while in the latter case all the light comes from all directions in the sky.

Since the final objective is to prevent bright light sources into the eyes of humans in the space, discarding the shades may be a possibility if the light from the LED sources are directed into such paths that no human eye moving normally in the space is likely to interrupt the path of light between the LEDs and the first scattering surface. This objective was never possible with the former light sources that emits light isotropically, but became possible with the LED light sources for the first time—and this is where our invention comes in. This in turn requires that the first scattering surface be arranged to be the ceiling, the upper wall or the floor, an arrangement which is possible only because the LEDs are fairly directional light sources. This is why the LED chips in the main embodiment of our invention are as it is shown in FIGS. 3c, 3d, 3e and 3f. Note that in FIG. 3d the people's eyes are further protected from bright light by a louver below the device. Accordingly, one of the modes of operation of our invention is to arrange the system in such a way that the fairly collimated light emitted by the LEDs are either above the eyes of standing adults in the space, or below the eyes of sitting humans in the space, or else at such an angle and path that the beam originating from the LEDs are unlikely to be intercepted by humans in the space. If one or more of these conditions occur, then humans in the space would not be inconvenienced by the bright LED beam, which would meet a diffuse scattering surface at a wall or the ceiling or the floor, from where light would diffuse on all directions and at a low luminance. All the variations of our invention are shapes of the LED supporting structure hem1 that cause the LED light to be directed to diffuse (non-specular) reflective surfaces, and in such a way that the high intensity, concentrated bright light from the LEDs, propagates through paths that are not likely to be intercepted by any human eye, generally for being either above or below the human's eyes. Some illustrations of this can be seen at the two provisional patent applications associated with this patent application.

Most former light emitting devices used for space illumination emit light isotropically, or at least quasi isotropically. Examples of traditional light emitters are the incandescent bulbs using the E27 Edison-style screw, the fluorescent tube style lights, and the halogen light, all of which emit light more or less equally in all directions (isotropically). Lasers, of course, do not emit isotropically, but lasers are not used for space illumination, so they are out of the group of light sources under discussion here, which are the group of light sources used for space illumination. Though this statement is obvious to everyone, what has not been noticed is that the directionality of the LED emitters affect their use for space illumination, which is the basis for our invention. The operating principle of our invention is the effect of the position and direction of the LED emitting elements on the distribution of light in the space. The operation of the invention is to mount the LED chips in such a supporting structure hem1 that the LED chips emits light towards a diffuse surface, as a wall, or a ceiling, or a floor, along such a path that the light beam has small to zero possibility of being intercepted by the eyes of any human performing the normal activities in the room before reaching the diffuse surface. If this occurs then there is no need for any shade surrounding the LEDs.

Let us analyze each of these by turn. Firstly, the luminance (that is, emitted visible light energy per unit area—see definition above) is a concern for some of the sources, not for all the sources. High luminance is definitely a concern for most of the incandescent bulbs used in homes, particularly for the older clear glass bulbs, while it is a smaller concern for the fluorescent tubular lamps used mostly in commercial buildings and offices. The reason why this is so is that the light emitting surface of the incandescent bulb is the small tungsten filament with a surface area of 1 square-millimeter, while the emitting surface of the fluorescent light tubes is the full surface of the 1 to 1½ in diameter, 3 to 5 ft long (2.5 to 3.8 cm diameter, 100 to 150 cm long) tube, or 2,000 cm-2=200,000 mm-2 area, which is almost a million times larger than the emitting area of the original clear glass incandescent bulbs!, so the luminance (luminous flux emitted per unit area) of the fluorescent tubes was accordingly one million times smaller, being bright but not offensively so. Old incandescent bulbs were originally sold with clear glass envelope, the tungsten filament was visible, and it was very uncomfortable to look at the filament while the lamp was in use. Most people today have never experienced this because by the time of their demise, clear glass bulbs have not been manufactured for a long time—but older people have used them and know it, and this occurred for a very good reason: to avoid bright light into the field of view of people around. Glass enclosures for incandescent bulbs have been made from a frosty glass for many years now, exactly to decrease the luminance of the clear glass bulbs (same luminous flux divided by the larger area of the frosty bulb). In these frosty glass incandescent bulbs, the light emanating from the bulb has been subjected to many scattering events as it propagates through the thin glass enclosure, causing that the effective emitting area is the much larger area of the frosty glass enclosure than the area of the incandescent filament inside the enclosure. Close attention will show the reader that our beautiful invention works on the same vein as the introduction of the frosty bulb, that is, to decrease the luminance, but our invention goes much further, with a much stronger impact.

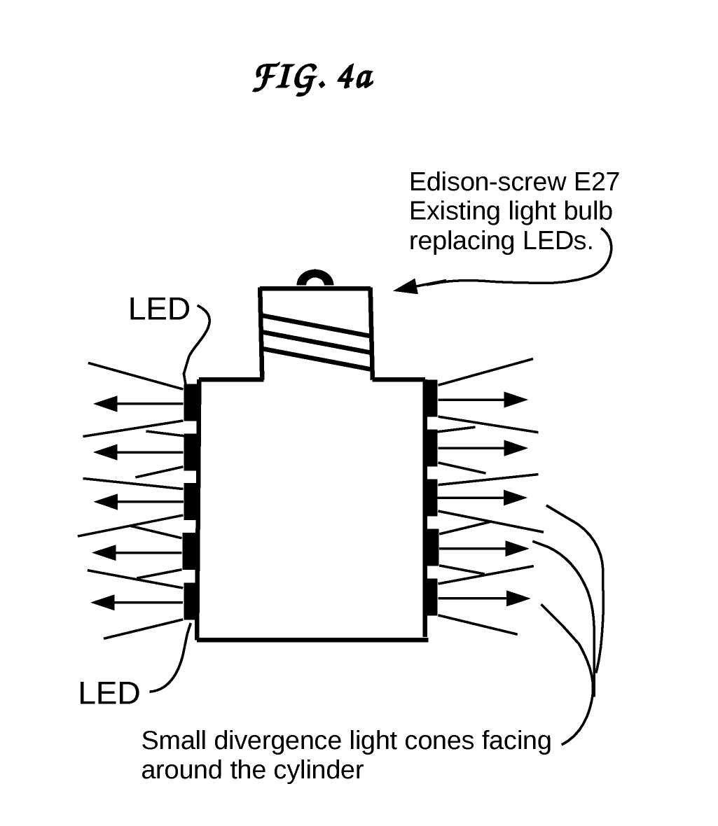

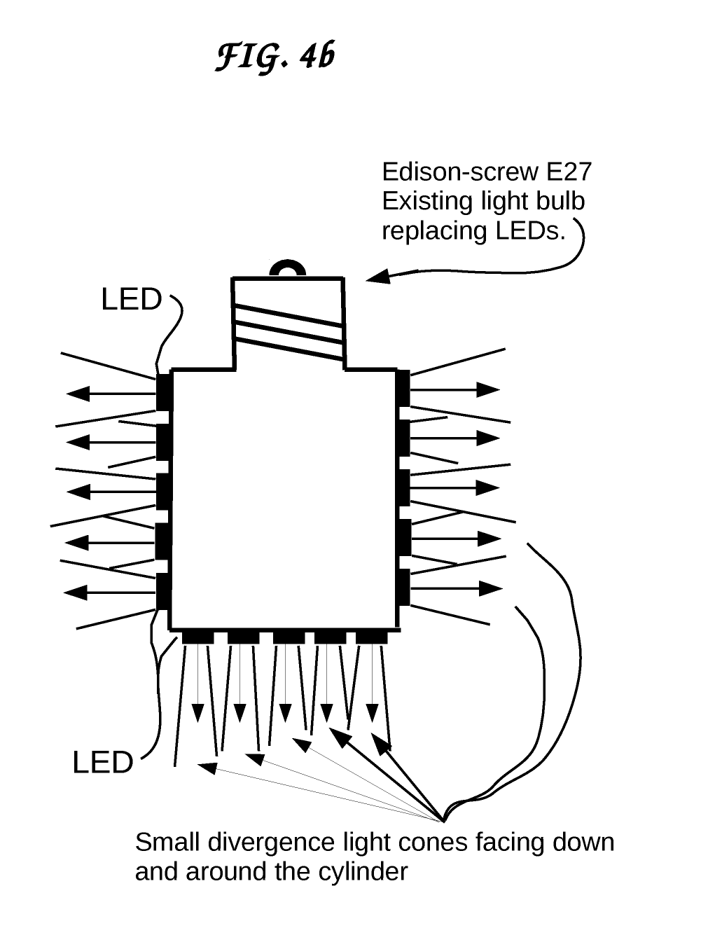

But even the frosty glass incandescent is borderline to look at directly (the surface area of the bulb is not large enough), which caused that a second, larger scattering surface was introduced surrounding the frosty glass bulb. This second scattering surface take different shapes, according to the location of the source—which turns out to be a relatively important part of our invention, determining, as it does, the several variants of our invention. The reader is referred to the two provisional patent applications associated with this regular application here for more information on the shades. The main embodiment of our patent is for ceiling incandescents attached to the ceiling at a vertical position and facing down, as per FIG. 3a. The solution to the problem of decreasing the luminance was the virtually universal use of a second, larger, scattering surface around the incandescent bulb, as depicted in FIG. 3b. With the recent introduction of the LEDs though, people simply sprinkled a few LED chips more or less accidentally on a physically and electrically compatible support, as seen in FIGS. 4a and 4b. These random creations do produce light but they fail to take the advantage of the directional characteristics of the LEDs. Our invention proposes instead the supporting structure supp1 as in FIGS. 3e and 3f (side view and perspective view, respectively). The advantage of our invention over the accidental creations that are in production today is that the existing LED luminaires are not built with the objective of keeping the LED light away from the people's eyes and therefore they require a shade as much as the old incandescent bulbs do. Existing LED luminaires are not designed to obviate the need for the second scatterer, as in FIG. 3b, which is achieved by our invention. Repeating it in other words, the operation of the main embodiment of our invention, which is designed for vertically oriented, facing down, ceiling mounted incandescent substituting LEDs, is to shape the LED chip support supp1 in such a way that the emitted light is directed toward the ceiling and toward the higher part of the walls around the room, at heights above the typical human height. Both the ceiling and the walls are typically light colors, so they are good reflectors, and moreover, a substantial part of the emitted light, due to the geometry of the device, hits the ceiling at a near grazing angle, causing a very high reflection as a consequence of the laws of reflections that are in turn a consequence of Fresnel's laws, as shown in the appendix. It is important to add here that our invention does not depend on any physical or mathematical theory, which is added here just as an argument for the soundness of the working of our invention.

Theory of Reflection/Fresnel Equations

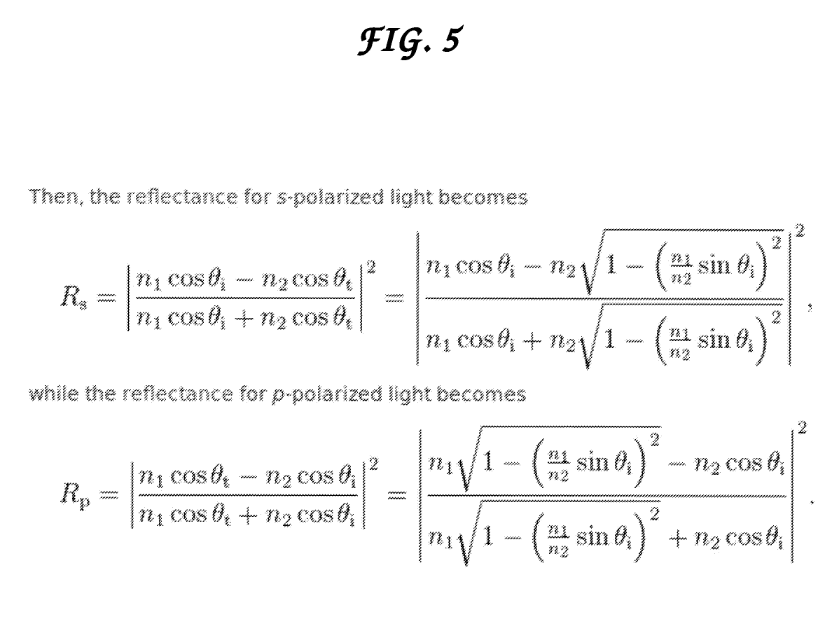

Maxwell's equations and the boundary conditions for the electric and magnetic field describe the behaviour of the electromagnetic waves (including light) at the intersection between two boundaries of different physical properties. In our case the boundary is between air and the painting on the wall, with indexes of refraction n1 and n2, respectively. The reflectance (fraction of light that is reflected) at any boundary separating these two media with different physical characteristics defined by their indexes of refraction, at angle of incidence θi and angle of transmission θt, at parallel (s) and perpendicular (p) polarizations, is given by the solution of the Maxwell's equations with the appropriate boundary conditions, which is known as Fresnel equations, as seen in FIG. 5.

Where, on both equations above, the transition from the middle form to the form at the right is a consequence of eliminating θt using Snell's law:

n1*sin θi=n2*sin θt

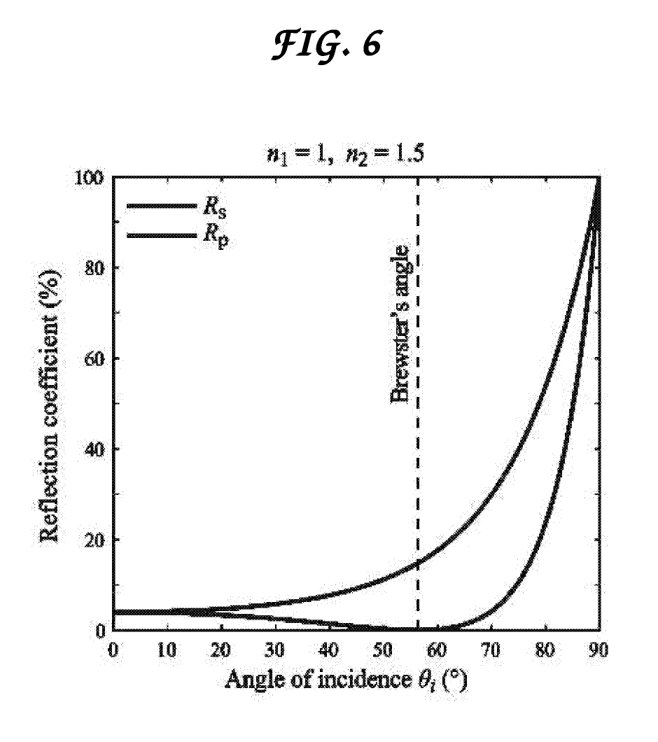

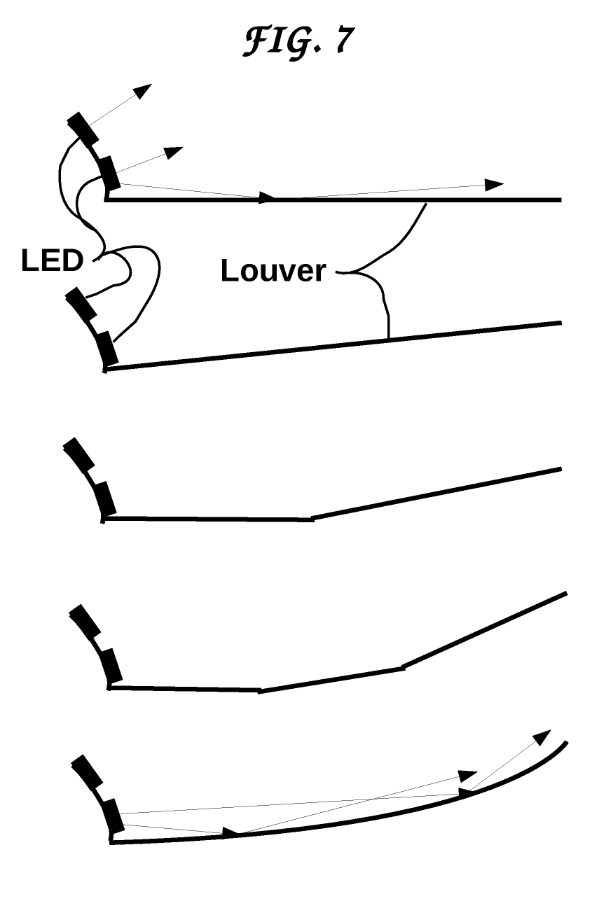

The graphs for the two Fresnel equations shown in FIG. 5 are shown at FIG. 6, where the lower curve is for the parallel component, and the upper curve is for the perpendicular component.

So, disregarding the small dip for the parallel component, the reflectivity increases with the angle of incidence (universally in physics, the angle arbitrarily measured starting at 0 dgs from perpendicular incidence growing to 90 dgs at grazing incidence). Since the objective here is larger reflectivity, so as to maximize light in the room, we want to maximize larger, or grazing angles of incidence.

### Description and Operation of Alternative Embodiments

There are many alternative embodiments and extensions for our amazing invention, some of which we make explicit here. The simple positioning of the individual LED chips, which alone is enough to spare the eyes of people in the room, may be complemented with the addition of louvers as shown in FIG. 3d, which adds another independent obstacle for light to propagate into the eyes of people. Louvers can be implemented in many shapes, some of which are illustrated in FIG. 7, many others being possible. Louvers may be white color, that is, diffuse reflectors, or may be specular reflectors, because either way light would be redirected to the ceiling, but specular reflectors may be preferred for the louvers.

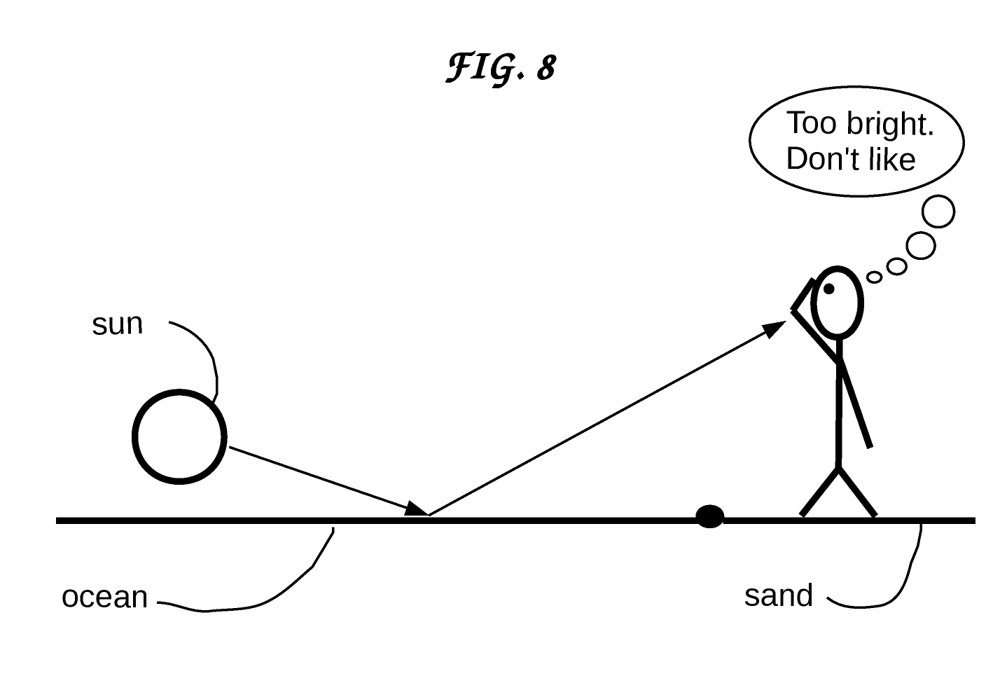

Another variation to the main embodiment is to deform hem1 to avoid that the light is emitted too close from being vertical direction (normal incidence on the ceiling), because according to Fresnel equations, normal incidence causes small reflectivity (see mathematical discussion at “operation of the invention above). Generally, grazing incidence is preferred for the first reflecting surface because the reflectivity is larger for larger angles of incidence. After the first reflection, it is generally difficult to force grazing incidence on the reflecting surfaces because by assumption light is then spread on all directions. Fresnel equation is of general validity and is the reason why the sunset is so bright when the sun sets over the ocean (grazing incidence on the water surface), as in FIG. 8, and why the black-top road appears to be wet at night, for people with the eyes low, as when seating inside an automobile looking at the headlights of an incoming automobile reflected by the black asphalt—the angle of incidence is measured with respect to the normal, close to 90 degrees in this case—just make a graph of it. In the black-top situation, our brain looks for an alternative explanation to the unexpected high reflectivity on the black pavement, which is interpreted to be water on the road, when in fact it is just Fresnel equation. It is interesting to note that the inventor, who is completely familiar with Fresnel equations, do not “see” water on the road in this situation, but rather sees Maxwell and Fresnel equations floating in the air ahead. Both cases involves grazing angle of incidence. This variation to the main embodiment is then to reshape hem1 to bend the hemispherical surface away from a closing hemisphere at the top, with the intention of causing the light emitted by the LED chips to hit the ceiling at higher angles of incidence, as shown in FIG. 9.

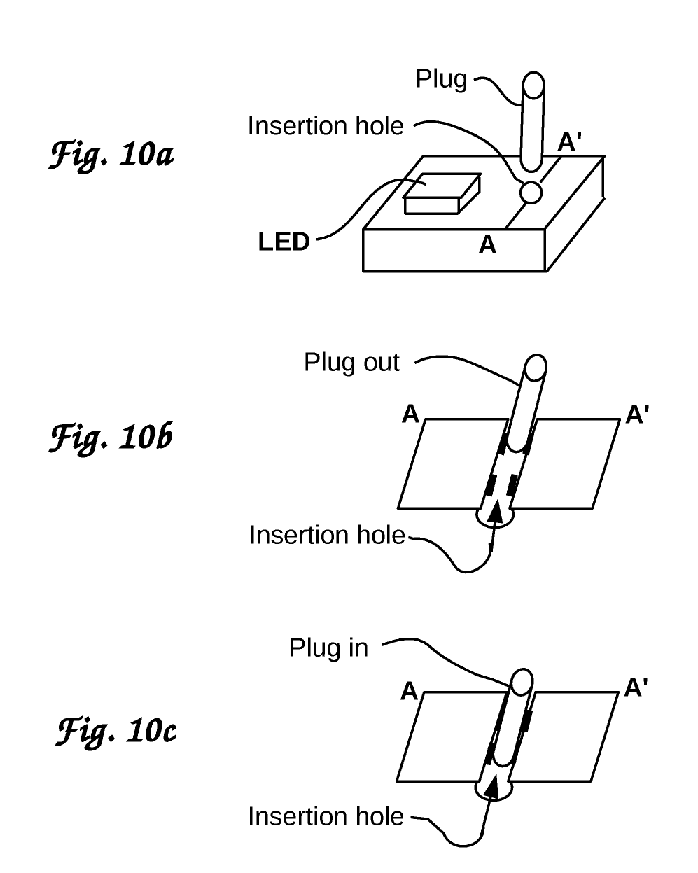

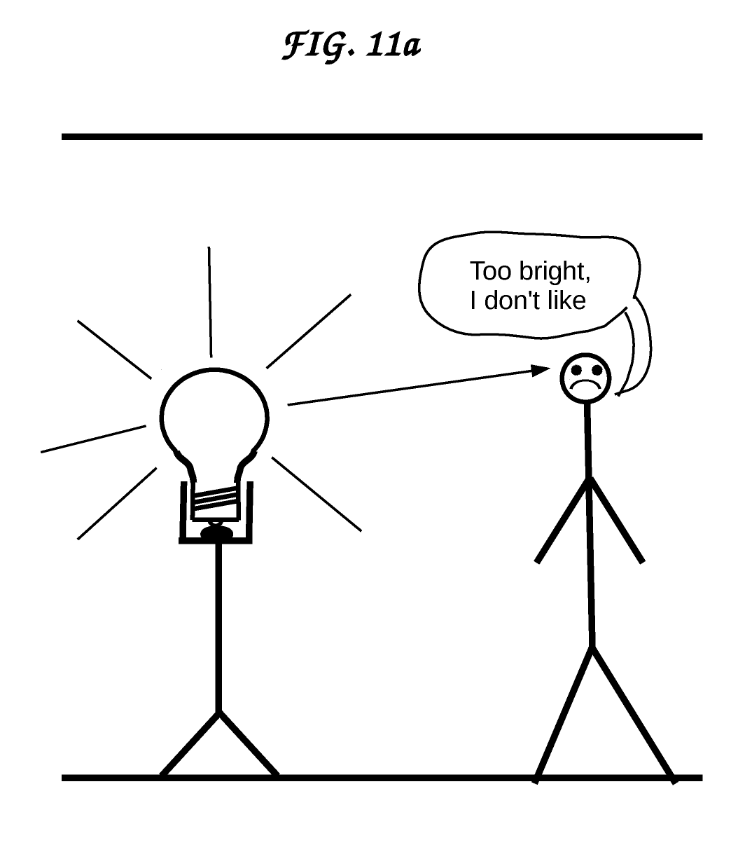

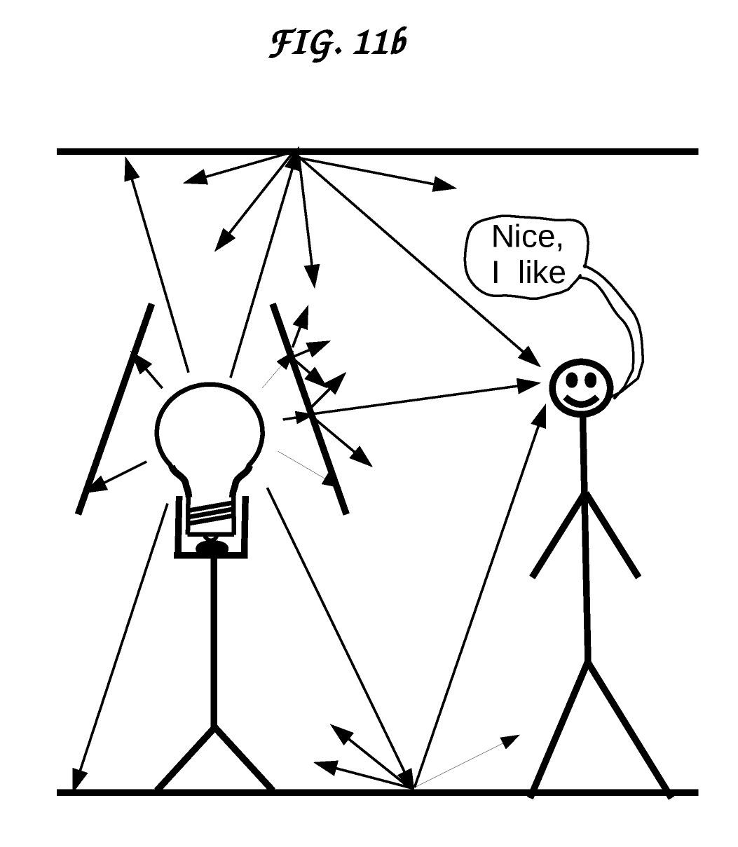

Another alternative is to add a switch to each LED chip or to a group of LED chips, which is capable of turning one LED chip or a group of LED chips on and off, as needed for a particular case, to cause emitting or not emitting light along particular directions. These switches can make fine adjustments on the LEDs that are on the “on” state and which are on the “off” state, therefore selecting some direction of light emission to be off, which may be needed for some particular case. Such switches would be used one time only, at the installation time, and perhaps never again for the life span of the device, which is very long indeed, some 30,000 hours minimum, which, at 5 hours a day amounts to 16 years of use. Therefore these switches need not offer easiness of change of state but rather manufacturing cost should be the deciding factor. Such a switch could be, for example, the type shown in FIG. 10, in which inserting the plug in the hole completes the circuit, turning the associated LED chip on, while pulling the plug out turns the associated LED chip off Instead of such a plug, any other of the existing switch technology may be used. In this case we show a case where each switch controls one LED chip, but it is conceivable that each switch may control 2, 3, etc. chips.

It may have occurred to the reader that the position of the LED chips on the hemispherical support hem1 of FIGS. 3c, 3d, 3e and 3f are a function of the location of the luminaire with respect to the likely position of the humans in the environment. This is of course true, and it follows from this that design variations on the relative position of the LED chips to the mounting support are needed for different situations. Some of these variations are described here.

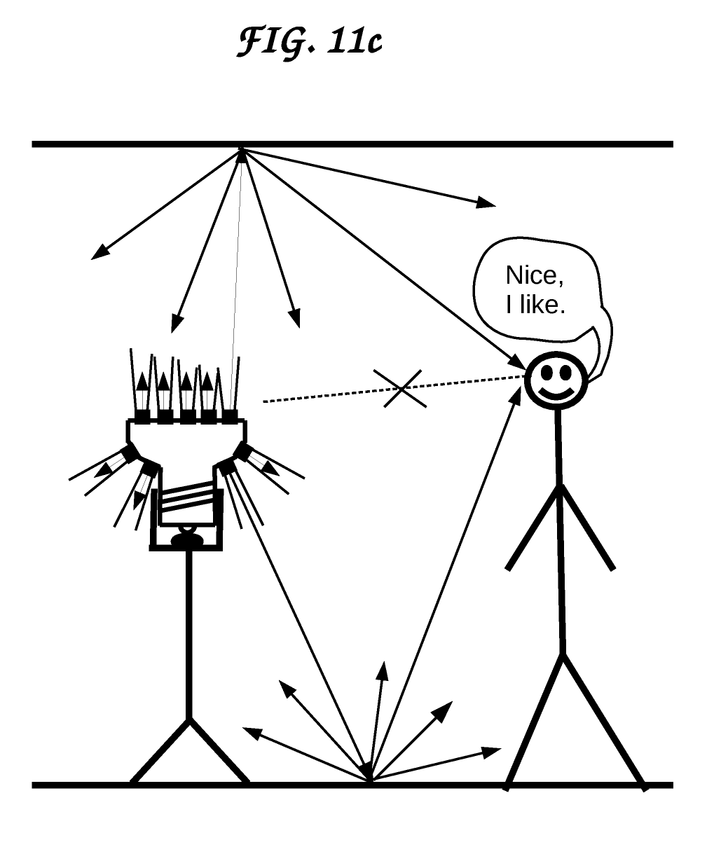

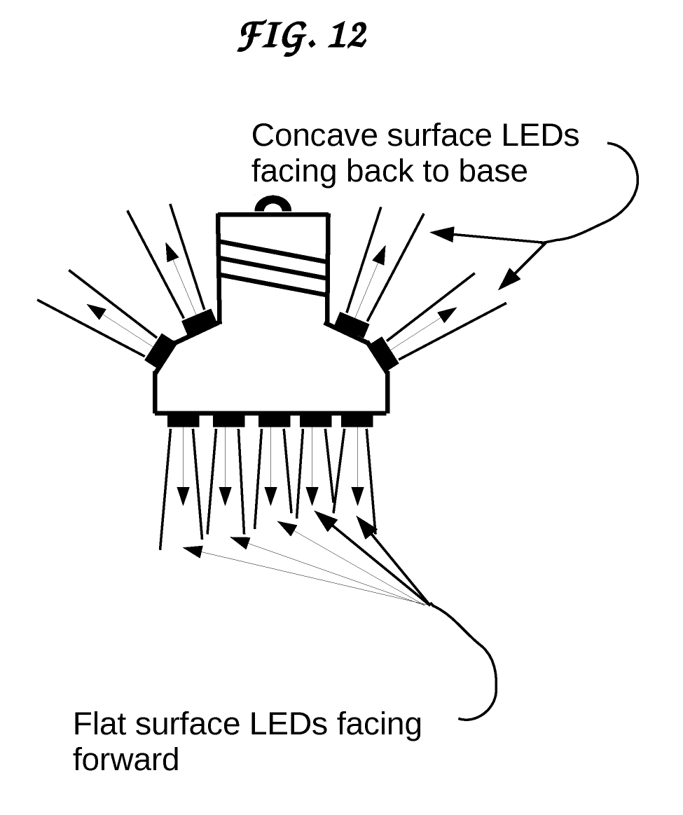

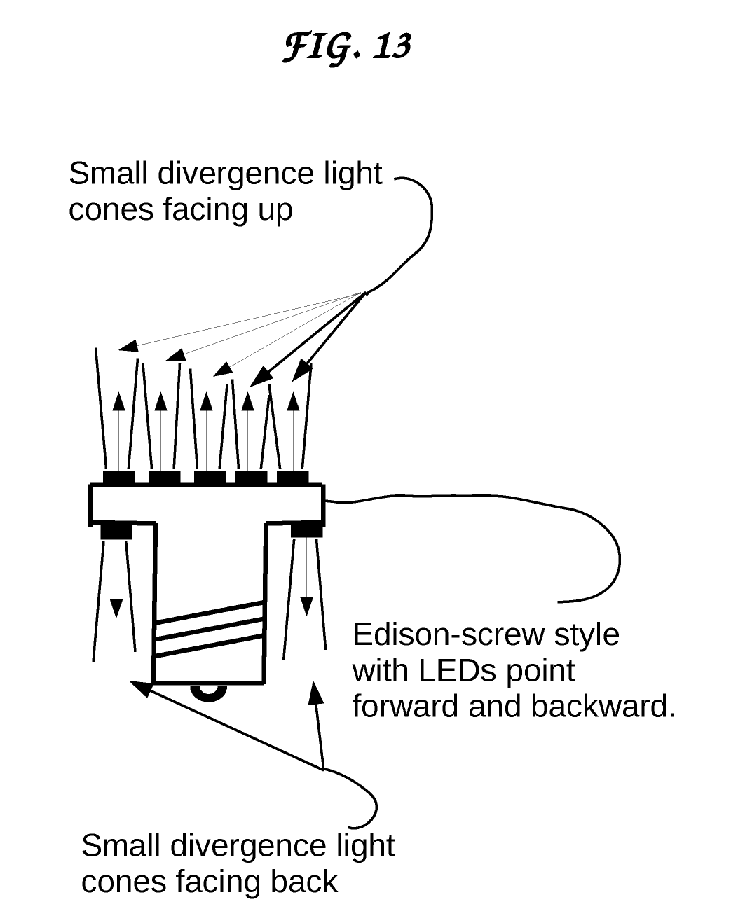

Another interesting alternative is shown at FIGS. 11a, 11b, and 11c. These figures display a common situation in US, where it is common that there is no light fixture at the ceiling, as is the case in most other countries, and the room light is provided by several light sources either standing on the floor (as in FIGS. 11a, 11b and 11 c, or on a piece of furniture (no figure). Both cases put the light source, which traditionally is an incandescent light bulb in US, just below eye-level, say, from 10 cm to 50 cm below eye level, a most unacceptable situation given that most of the time people in the room have their eyes near the horizontal. It follows that these lamps always have a shade on them. As displayed at FIG. 11a, without any sort of shade, the incandescent light bulb is too bright and would annoy most people, besides causing spooky shadows, so all these lamps are fitted with a shade—the inventor have not seen any exception. In these cases where the lamp is just a little below eye level, the shade is designed to scatter the light emitted on a horizontal trajectory. Since it is only the horizontally propagating light that is needed to be scattered, these shades are then open at the bottom and at the top, emitting direct light both up and down, directions from which it is unlikely that any human will be. FIG. 11b shows such a lamp with such a cylindrically-shaped shade, or, more often, some modified cylindrically shaped shade that is adjusted for decoration too, together with a human. Then finally, FIG. 11c shows the LED-based E27 luminaire of our invention for such a situation. There is no need for any shade because the LED chips are directed vertically up and down only, perhaps with a hemispherically mounted lower array of LEDs, given that most of these lamps are below eye level. Note that a hemispherically mounted upper array would be bad in this case—just make a drawing of it! The variation with a hemispherically mounted lower array of LEDs would be positioned such that the hemispherically mounted lower array of LEDs would face the lower part of the wall, away from human eyes, and the floor. Again this alternative positioning of the LED chips on sup1 obviates the necessity of the shade, and because these shades also absorb some light, decreasing the possible illumination, the LED-based E27 does again offer an extra energy efficiency, which is the elimination of the absorption caused by the shades. FIGS. 12 and 13 show in more detail the preferred LED chips positioning for this luminaire type.

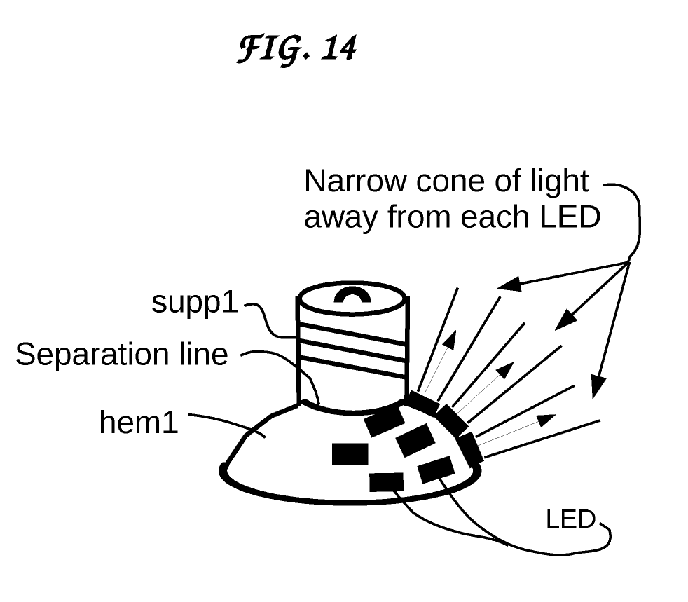

Another important alternative embodiment is shown at FIG. 14. This alternative embodiment has the supporting hemisphere hem1 populated with LED chips on an angular wedge

θ=p/q(360) dgs

with p<q, so θ<360 dgs. The supporting hemisphere hem1 is also so constructed that it is capable of rotating around its central axis. Rotating the hemispherical support hem1, the LEDs occupying a fraction p/q of the circumference point to any desired angular direction that is necessary, therefore choosing the illumination direction. This is a good feature that allows for local adjustment of the emitted light. For example if p/q=½, then the LED span half of the circumference of hem1. A situation in which such an LED-substitute for incandescent bulbs would be good is the case of nearby dark colored walls, toward which it would be inefficient to emit light, or when much of the wall on one side is taken by windows. Such a half-hemisphere emitting LED would keep the dark walls or the window opening not illuminated. This variation of the main embodiment is shown in FIG. 14. The fraction p/q may assume values as ¼, ½, ¾, or any similar fractions but the actual numerical value does not change the principle of operation, each one being suitable for a particular case.

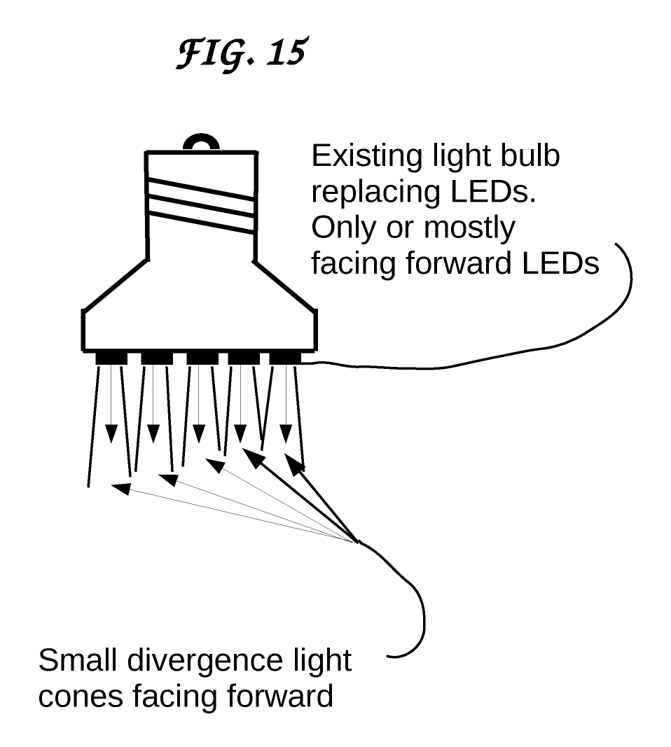

Another variation is for the less common multiple E27 bulbs at the ceiling with the bulbs mounted on a horizontal direction. This is common for cases designed for multiple incandescent bulbs, as 2 or 3 bulbs in the same bay at the ceiling. In this case the best position for the LEDs would be at the forward ending of the support supp1, or forward and backward, as shown in FIGS. 15 and 13. The forward light emitting device cannot be patented because it is already for sale (what a bummer!)—though the manufacturers had no intention to keep the light away from the eyes of people in the room, but the forward and backward light emitting is new and is part of the alternative embodiments of our fantastic invention.

Another alternative embodiment is to assign a digital address to each of the chips in each LED, which can then be turned on and off, and when turned on to have their luminous power controlled at the will of a human operator with a radio controller at a distance. The controlling device may be similar to a remote control for a stereo or TV, similar to a bluetooth device, and many other possibilities. The particular technology used for the action-at-a-distance is established technology, in this case to send control and address bits to direct a local microcontroller at the light to control electronics circuits that turn on or turn off individual LED chips and to increase or decrease the luminous power of each chip under the control of a human being according to his/her needs.

Another alternative embodiment is to assign a digital address to each of the chips in each LED, which can then be turned on and off, and when turned on to have their luminous power controlled at the will of a human operator with an electrical signal that is transmitted by the electrical mains (120 VAC in US), operating at a different frequency than the electrical mains (different than 60 Hz).

Another alternative embodiment of our invention is adaptations on the LED substitutes for the fluorescent long tubular lights used mostly in offices, schools, stores and government buildings, that is, most non-residential users. These long, tubular fluorescent lights have an almost tolerable luminance, because the light emitting surface area is so much larger than the frosted incandescent bulb. Because the luminance of the fluorescent lights is smaller than a an equivalent incandescent light bulb with the same luminous flux, there exists quite a number of fluorescent tubes that are not enclosed in any extra frosty enclosure, particularly older buildings. Observing the use of fluorescent tubular lights in several places we came to believe that the cases with the fluorescent lights behind a frosted cover seems to be due more for architect's irrational attachment to flat surfaces than for need to further increase the emitting surface area. Much light is lost in these frosted covers, but it seems that the architects do not worry about this.

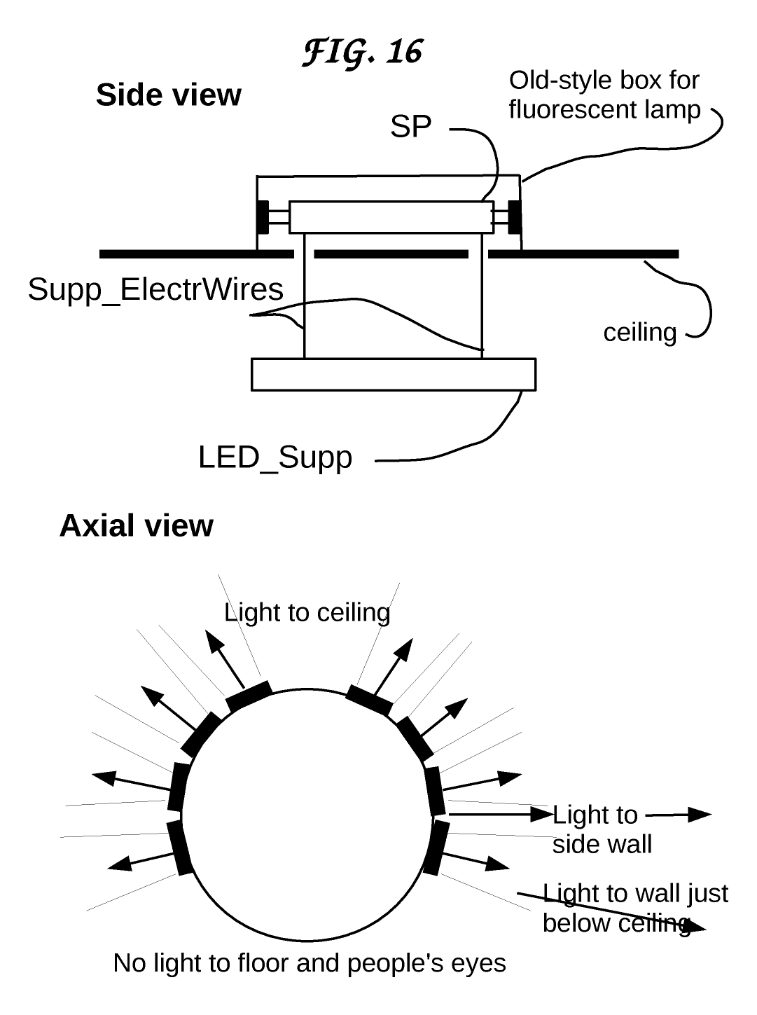

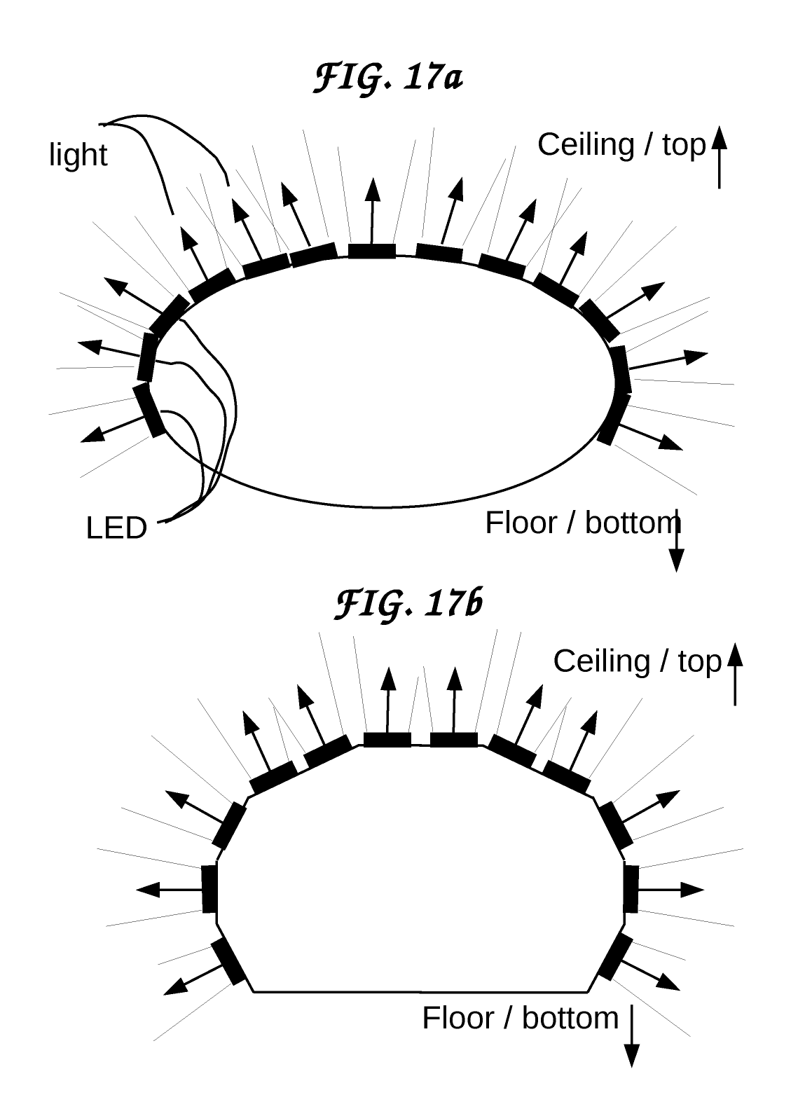

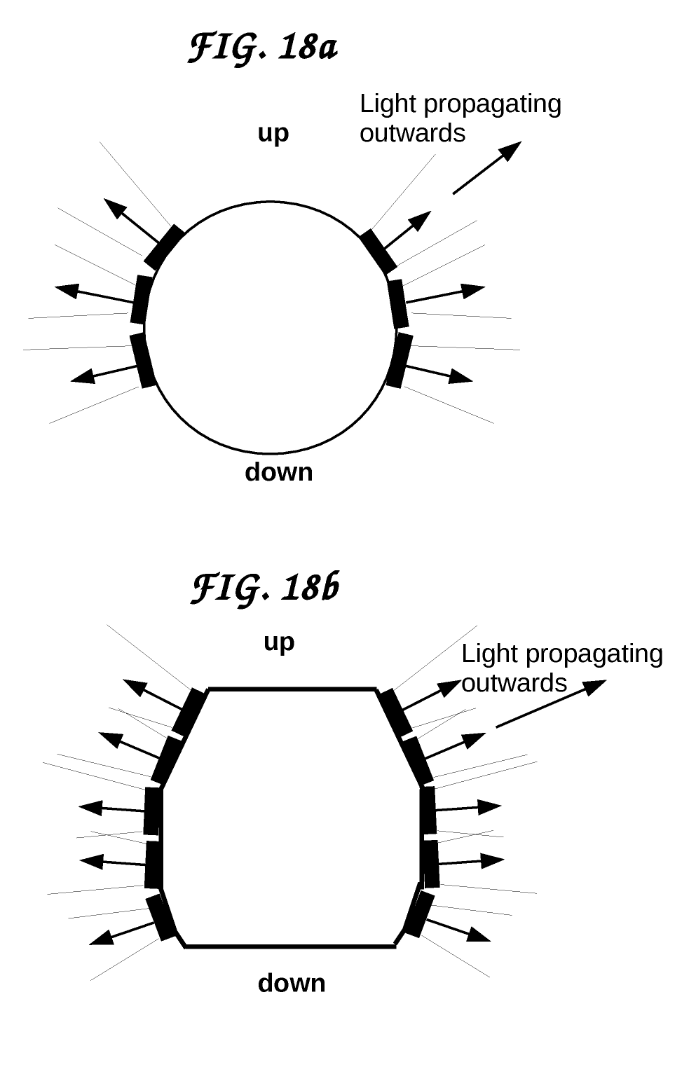

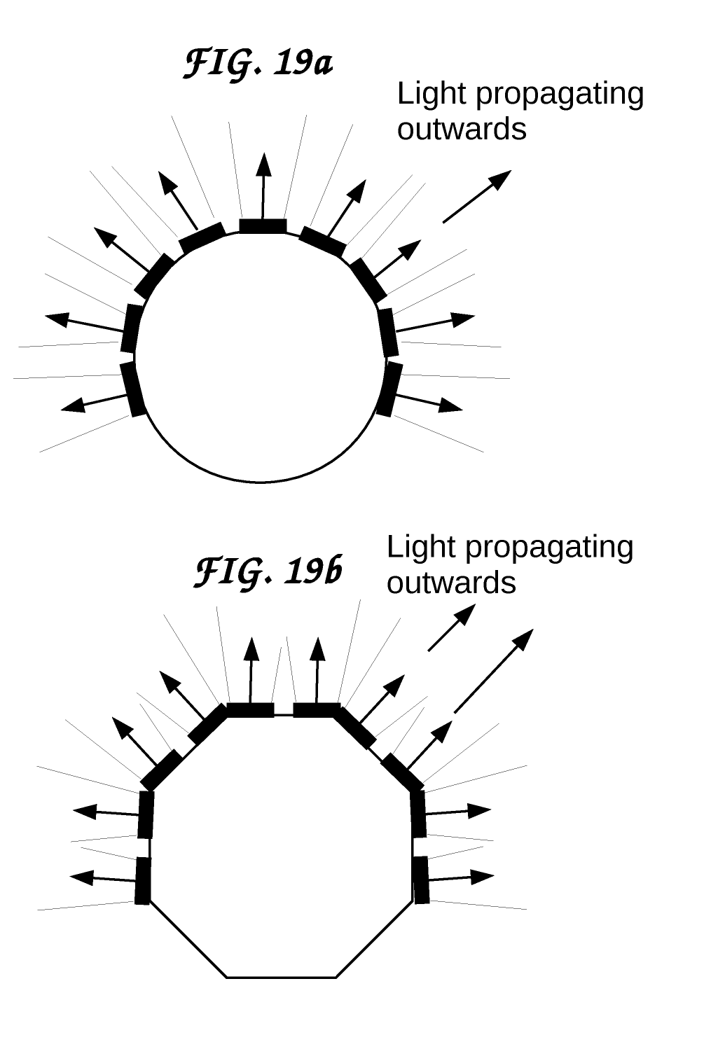

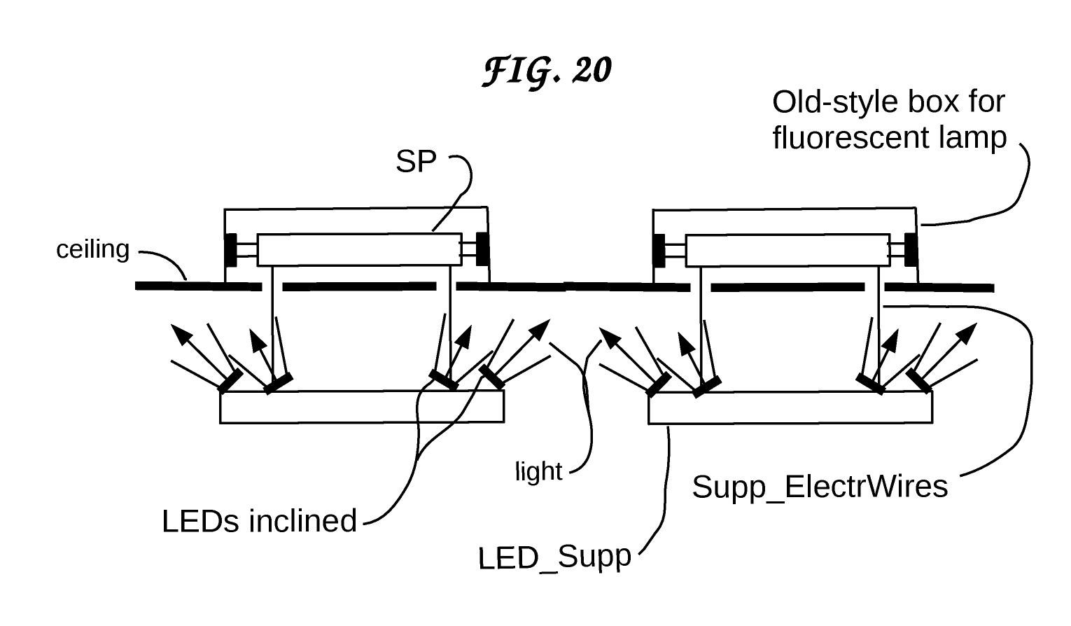

A possible alternative embodiment for the long tubular fluorescent lights is shown in FIG. 16. This figure shows a fluorescent long light from two views: side view at the top and front, or axial view at the bottom. The view at the top does not include the LED chips, which can be seen only in the bottom view (axial). This figure represents a possible alternative embodiment for a fluorescent style luminaire that encases the fluorescent lamps inside a closed box inside a faux ceiling, as common in recently built offices etc. This current fashionable luminaire is a box embedded into the faux ceiling, inside which there are some 3, 4, or so fluorescent tubes, the lower part of the box being covered by a cheap plastic sheet that is frosty and often with a faceted surface, the small sides of which measure some 1/32 inch or so, which contribute for the diffusiveness that the plastic is supposed to have. This modern luminaire is very energy wasteful, so our best alternative embodiment for these includes hardware that lowers the LED substitution below the faux ceiling, as shown at the top of the figure, a change that causes that all the light energy is emitted in the desired space without need for the diffuse scatterer that also absorbs light energy. As seen in the bottom of FIG. 16, the light produced by the LEDs is directed upward to the ceiling, from where it scatters to the full space. The variation shown in FIG. 9 may be incorporated in this variation too. Other modifications of this variation are shown in FIGS. 17a, 17b, 18a, 18b, 19a, 19b and 20.

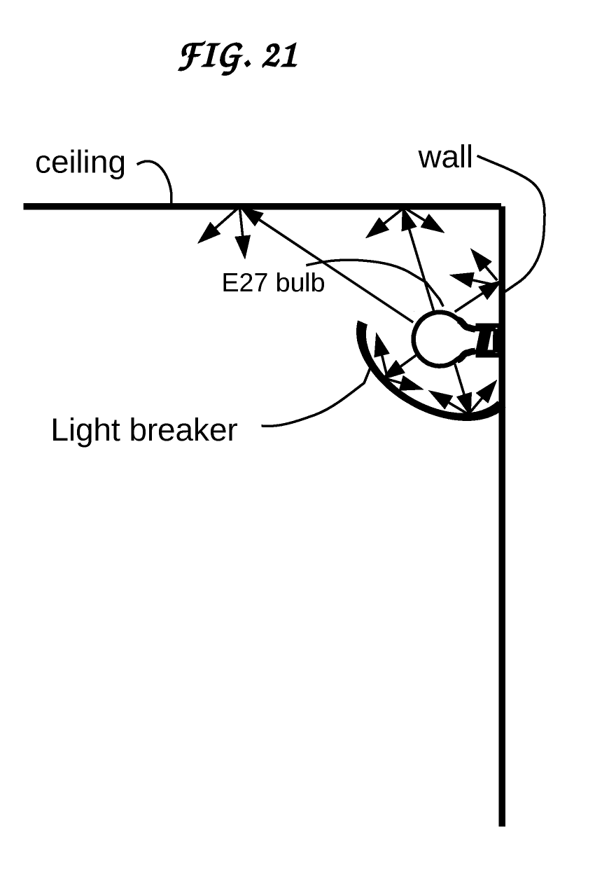

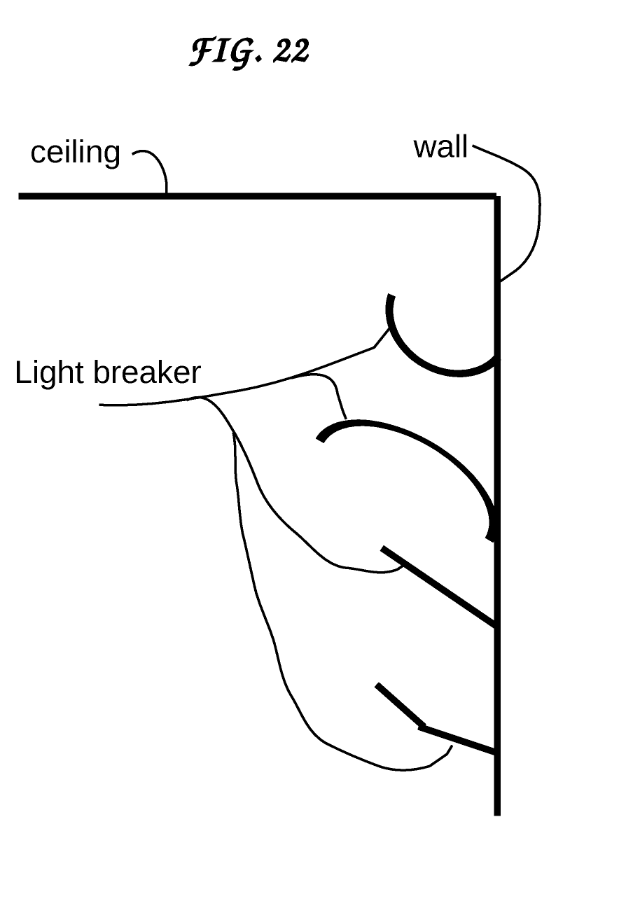

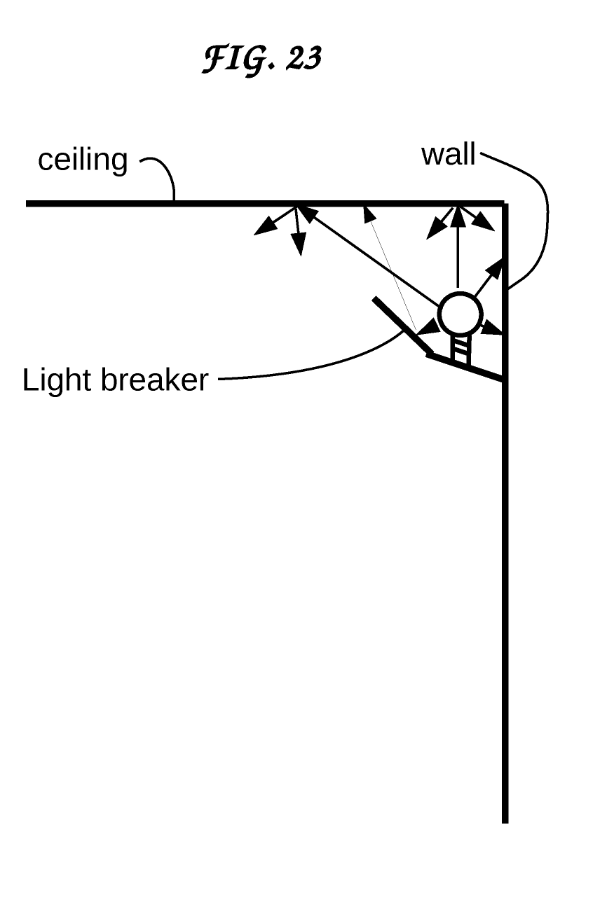

Another alternative embodiment of our invention is for use associated with indirect lighting. We want to call the attention of the reader that the so-called indirect lighting is a variation of the standing lamps with shades, both being designed to increase the surface area for a fixed light luminous flux (light energy originating from the inner source, perhaps an E27 incandescent) from which smaller luminance (light emitted per surface area of the ceiling) spreads to the room (or space in general). In fact, with the exception of searchlights and auto and bicycle headlights, all other illuminating device strive for this same goal of creating a large surface area with low luminance light originating system (dim, not bright), the indirect lighting just being up-front with the objective. FIG. 21 shows a side view of a wall with such an upper wall light breaker near the ceiling, and FIG. 22 shows 4 exemplary shapes for the light breaker. FIG. 23 is similar to FIG. 22 except for the direction of the incandescent bulb: horizontal in FIG. 21, vertical in FIG. 23.

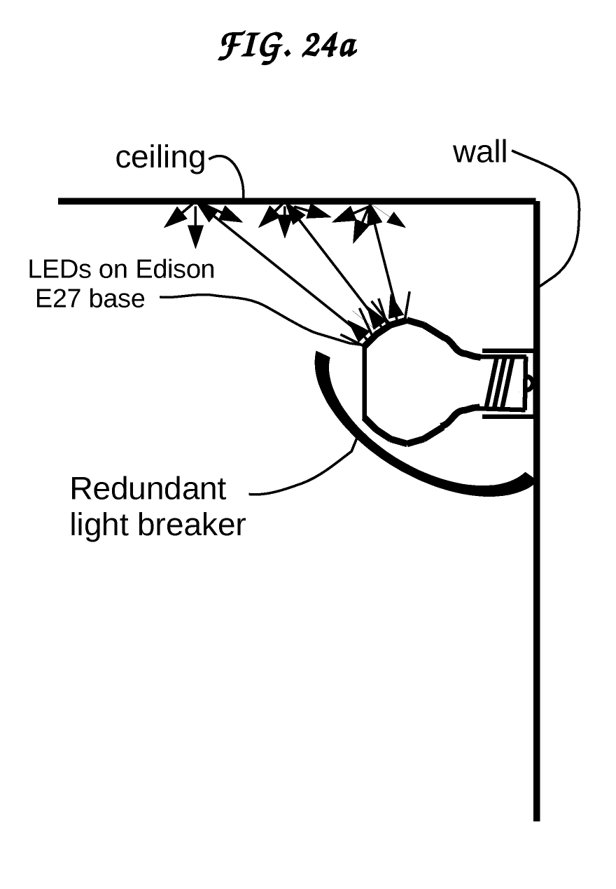

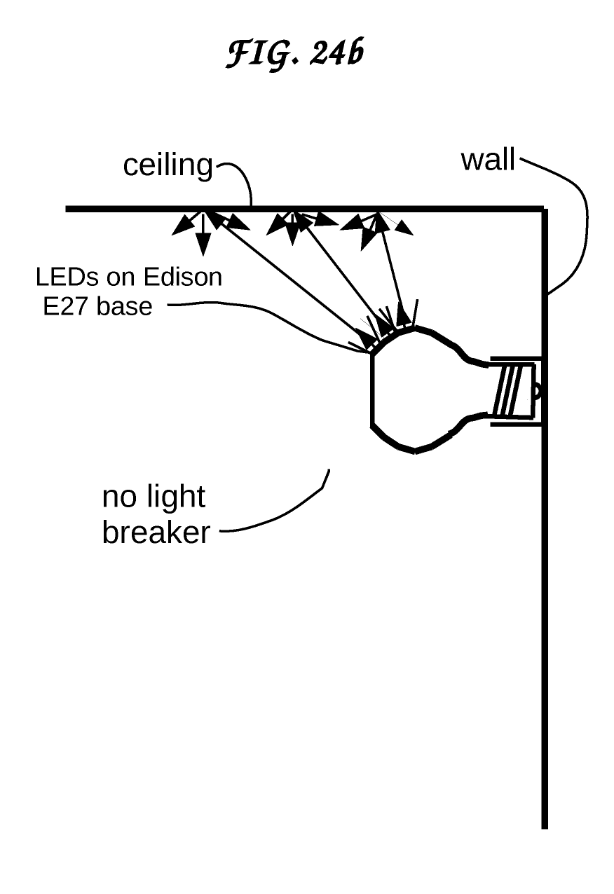

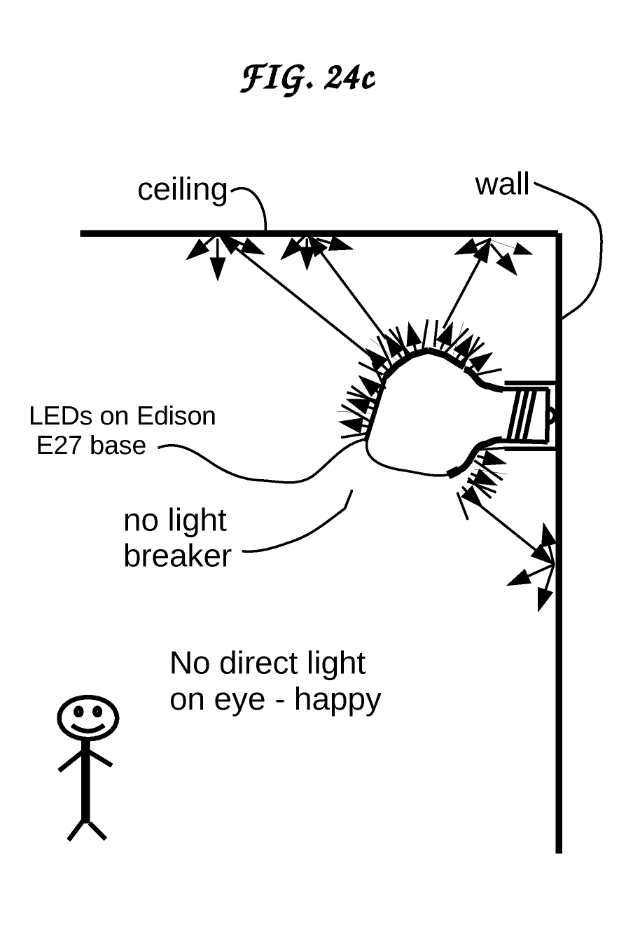

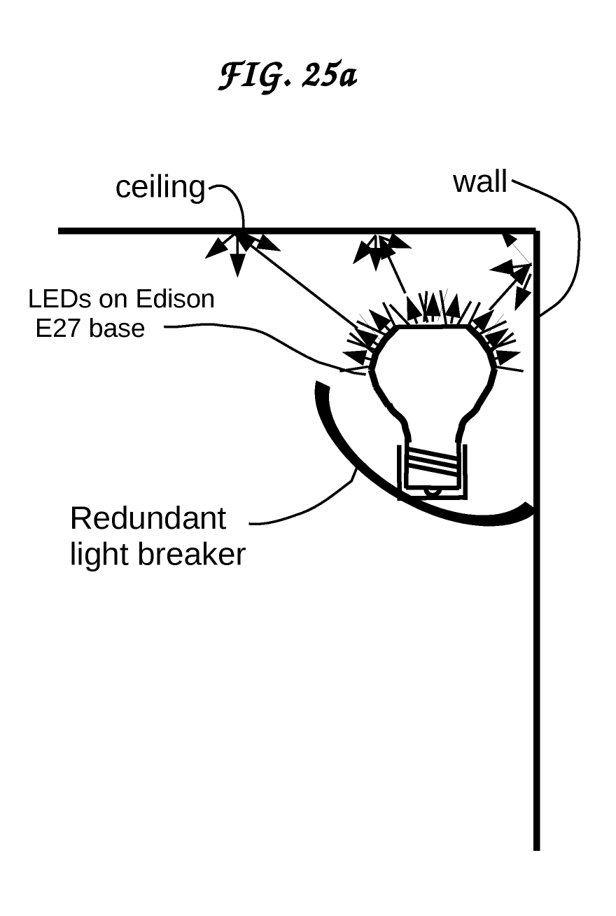

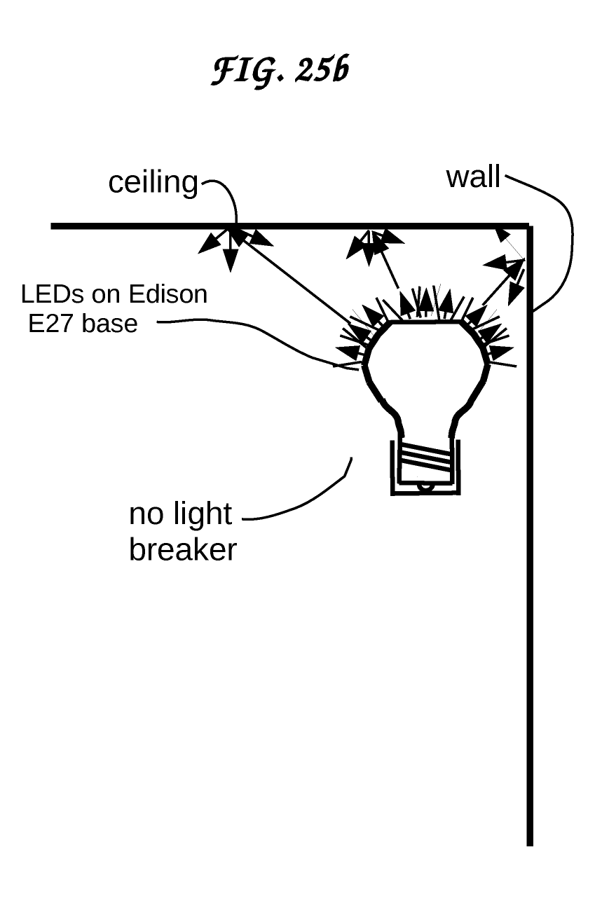

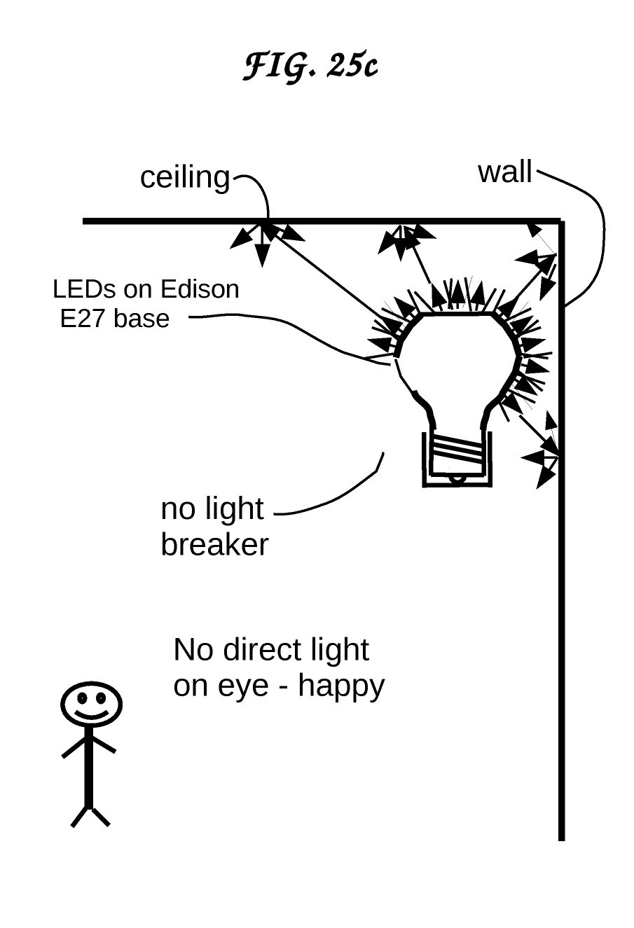

As the reader may be guessing now, it is possible to eliminate the light breaker used for indirect lights with the luminaire of our invention, with the same energy savings created with the elimination of the shades for the main embodiment, due to elimination of light absorption in both cases. Two examples of this is seen at FIGS. 24 and 25 (a, b and c). What is seen in these figures are the simple substitution of the ordinary, isotropic (emit on all directions) incandescent E27 by one LED-based, E27 mounted luminaire of our invention, emitting in the appropriate directions. FIG. 24 is the improvement caused by our invention on a horizontally mounted incandescent E27 light bulb, while FIG. 25 is the improvement caused by our invention on a vertically mounted incandescent E27 light bulb. Or, saying the same in different words, FIG. 24 is the improvement of our invention on FIG. 21, and FIG. 25 is the improvement of our invention on FIG. 23. Both 24 and 25 are split in three subdivisions, namely “a”, “b” and “c”. In both FIGS. 24 and 25, “a” shows a simple substitution of an adapted E27-type support with LEDs on the appropriate directions such that the light breaker is redundant (it does nothing, because with the particular LEDs no light is emitted down to be blocked by the light breaker), “b” is a repetition of “a” without the redundant light breaker (since it does nothing, it better be taken out), and “c” is the best LED arrangement without the light breaker.

Many other shapes are possible and are intended to be covered by this patent application. The light breakers often have some ornamentation for decoration, which is not part of this invention. In fact, as seen above, illustrated by FIGS. 24 and 25, our invention makes the light breaker redundant: when an LED of our invention is used as a substitute for an older E27 the result is “energy savings”, and when a new indirect lighting is built from scratch, the light break is not even necessary, because our devices only emit light to the appropriate directions, never to the human's eyes that the light breaks exist to protect. FIG. 23 shows a wall light breaker with one of the dinosaur incandescent bulb emitting light to all directions. Part of the light that happens to be emitted below the horizontal, light that potentially would have propagated towards a human eye in the room, is then reflected by the light breaker, then perhaps, after a few reflections inside the light trench will emerge towards the ceiling, from where it will suffer a diffuse reflection into the room. The multiple diffusions inside the light trench are each associated with a probability of absorption, each one decreasing the energy efficiency of the indirect lighting. The point here is that light that is emitted downward suffers multiple diffuse reflections in the light trench before escaping upwards to become eventually available as room light, but part of it is absorbed at each reflection, causing energy inefficiency. If one were to use instead an LED of our invention with the LED chips directed to the openings of the light breaker, that is, upward emitting light, as in FIGS. 24a and 25a, then there would be no light emitted downward and some of the unnecessary reflection would be avoided, increasing the energy efficiency of the device. The immediate continuation of FIGS. 24a and 25a are 24b and 25b, which is the same as the “a”'s figures omitting the redundant light breakers altogether. Finally FIGS. 24c and 25c are the continuation of the “b”s, in that the “smart” LEDs of our invention may also emit light downward toward the wall, as seen in the “c”s series.

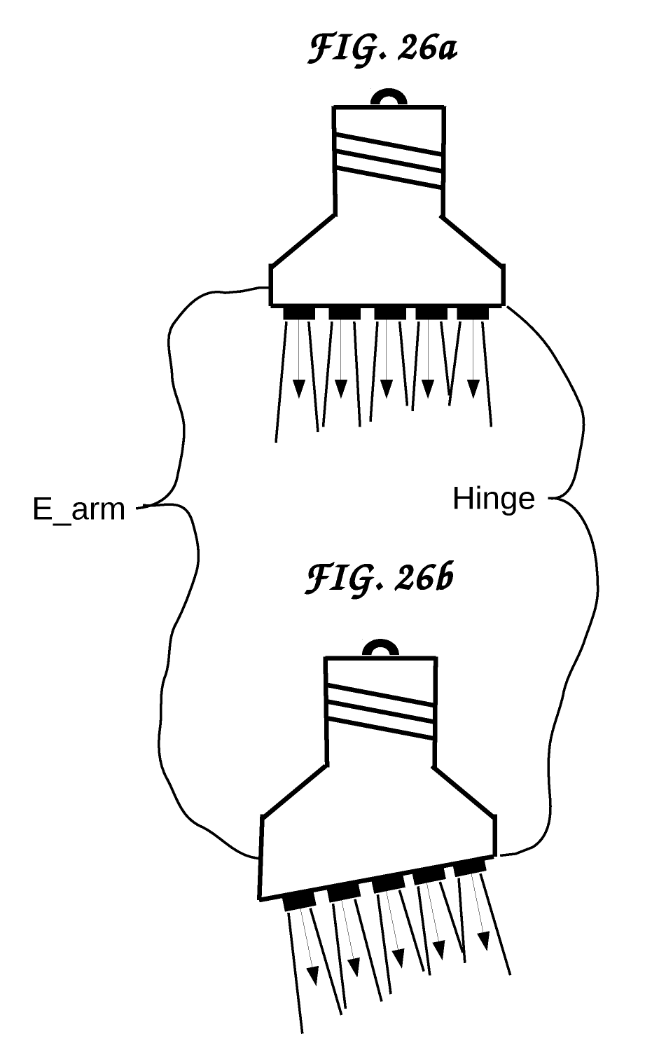

An extension of this is to include the rotatable emitter variation of our invention, as seen in FIG. 14, which can be used to select the direction to illuminate from a particular position near the upper wall corner as depicted in FIGS. 24 and 25. Another extension or variation of FIG. 14 is a part of the surface of the extendable arm Earm which is capable of being moved in and out, causing that a surface populated with LEDs rotates around a hinge, therefore changing the angle of the LEDs, and therefore the direction of the emitted light. This is shown at FIGS. 26a and 26b.

As the reader can now see, many types of LED chips distributions on the body of the substitutions for the E27 can be devised. In practice, due to market considerations some compromise will be made on the LED chip distributions that are sold in the stores, with the possibility of easily making on-order modifications of the ones mass produced.

Another variation (no shown) is to have a mirror on some surfaces that are supposed to become the first reflecting surface, or the second reflecting surface, etc., but not for all reflecting surfaces (if all surfaces were reflecting, the LED beam would eventually reach people's eyes without suffering scattering-spreading events and would therefore be too bright). For example, on the improvement of our invention for the indirect lights at the higher part of a wall, above the LEDs, against the wall, there could be a mirror to reflect any light to the ceiling, where it then would be diffusively scattered. Stating the same thing in different words, a mirror attached to the upper part of the wall and above the LEDs would specularly reflect all the light falling on it towards the ceiling, from where the light would be diffusively reflected to the room at low luminance.

As the reader probably have noticed, other positions and heights of the Edison socket require different positions of the LED chips on the supporting structure. Each direction and height of the Edison socket requires a different LED arrangement in order to (1) keep the light beam emitted by the LEDs outside the path where the eyes of people may pass, as, for example, predominantly above or below the eyes of the people in the room, and (2) avoiding the use of shades that cause absorption, and consequently adversely impact the energy efficiency of the light source.

Other variations are also possible, which are intended to be covered by our invention.

### Examples of Intended Use

One example of intended use of the main embodiment is for the ceiling vertically mounted LED-substitutes for the dinosaur incandescent bulb known as Edison-screw, E27.

A second example of intended use of the invention is for lamps either standing on the floor or on some piece of furniture. FIGS. 11a, 11b and 11c show a few examples of these. In this case, where the LEDs are approximately at eye-level with people's eyes, the LEDs are emitting light vertically both up and down, in both cases avoiding people's eyes. This option would also function with LEDs emitting only up or only down. Most Edison E27 for shaded lamps are vertically mounted, most of them facing up, a few facing down.

A third example of intended use of the invention is for lamps behind an upper ceiling light breaker around the room, which exists in some rooms, sometimes called indirect lighting.

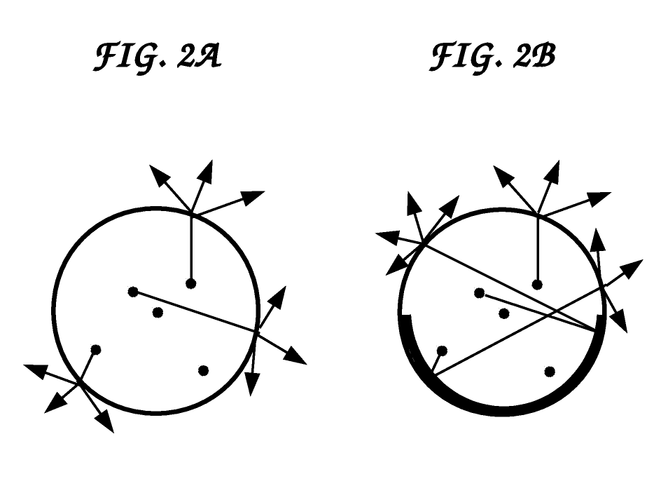

A fourth example of intended use of the invention is for fluorescent tube style lamps, of the type usually found in businesses, schools and offices. FIGS. 2a and 2b show fluorescent lamps from an axial view, while FIG. 2c show one possible incarnation of our LED invention for LEDs, with LEDs pointing toward one direction only.

A fifth example of intended use of the invention is to substitute for halogen luminaries used for home and shop illumination. These are generally low voltage small sized lamps, easy to substitute by an LED with the appropriate LED direction.

A sixth example of intended use is for bicycle lights. The use of LED for bicycle lights is very advantageous because bicycle lights either run from a battery or from a local generator, both of which can supply a limited power. Whether powering the bicycle light from a generator or from a battery that must be light weight in a bicycle device, it is much better to use less energy. Moreover, many bicycle lights are halogens, because these are more energy efficient than incandescent, and low voltage, easily substituted by the LEDs.

### CONCLUSION, RAMIFICATIONS, AND SCOPE OF INVENTION

Thus the reader will see that the light emitter of the invention provides a highly reliable, simple, yet economical device that can be used by persons of any age and skill, which, being compatible with the light emitting devices currently manufactured and used, can be inserted in the existing infrastructure with a measurable positive effect on the energy use (popularly said “energy savings”).

While my description contains many specificities, these should not be construed as limitations on the scope of the invention, but rather as an exemplification of one preferred embodiment and a few of the many possible variations of the main embodiment to adapt the concept to the several standard in use and for the several possible uses of the device. Many other variations are possible. For example, the LED chips may be 4 by 4 mm, or 8 by 8 mm, or 1 by 1 mm, or 1 by 2 mm, etc., or many other sizes, without changing the concept of the invention. The LED chips may be of the type that emit visible light, as in the main embodiment, or they may be of the type that emit ultraviolet, or they may be of the type that emit infrared, or any other electromagnetic radiation, without need to alter the fundamental principles of the invention. The main embodiment was described for an indoor use, but the same principles apply for outdoor use, or use inside cavities of difficult access, as inspections of pipes and inside the human body by laparoscopy, and many others.

Accordingly, the scope of the invention should be determined not by the embodiments illustrated, but by the appended claims, by the figures, by the extensions explained in several parts of the patent application, in the associated provisional patent application, in the claims and their legal equivalents.

### SEQUENCE LISTING

N/A

1. A method for distributing a light to illuminate a space, the method comprising:
providing a supporting base capable of providing mechanical support and electrical connections to an electrical energy source,
providing a supporting surface mounted on the supporting base such that the supporting surface is capable to provide physical support and electrical connections for a plurality of at least one LED chip which is capable of emitting light,
designing the shape of the supporting surface that provides physical support and electrical connections for a plurality of at least one LED chip capable of emitting light to illuminate the space, wherein,
arranging the shape and position of the supporting surface attached to the supporting base at a preferred location and at a preferred orientation such that the shape, location and orientation of the supporting surface causes that at least one of the plurality of LED chips is at a preferred position in the space and faces a preferred direction in the space,
adjusting the shape of the supporting surface such that the light emitted by at least one of the plurality of the LED chips is along the propagation paths from the emission of the light until its first scattering event, wherein;
the light emitted by at least one element of the plurality of the LED chips is confined to at least one path from the set:
1) light paths such that the initial light beam after being emitted by the LED chip and before a first scattering event propagates at heights higher than 5 feet 5 inches,
2) light paths such that the initial light beam after being emitted by the LED chip and before a first scattering event propagates at heights lower than 1 foot,
3) light paths such that the initial light beam after being emitted by the LED chip and before a first scattering event propagates at angular orientation such that no light beam crosses from below the height of 1 foot or from above the height of 5 feet,
the shape of the supporting surface that provides physical support for the LED chips is such that at least one of the plurality of the LED chips at the surface of the supporting surface emit light in a direction that is determined by the shape of the supporting surface,
at least one of the plurality of the LED chips emit light with a divergence angle smaller than 90 degrees

2. The method according to claim 1, further providing a louver at such a location and direction as to further block the paths of the light produced by at least one of the plurality of the LED chips to propagate within the heights of 1 foot and 5 feet.

3. The method according to claim 1, wherein the support structure is fitted with a louver at such a location and direction as to further block the paths of the light produced by at least one of the plurality of the LED chips to propagate within the heights of 1 foot and 5 feet.

4. The method according to claim 1, wherein the base support and the supporting surface are combined in a single entity.

5. (canceled)

6. (canceled)

7. The method according to claim 1, wherein the supporting surface is concave.

8. The method according to claim 1, wherein the supporting surface is convex.

9. An apparatus for producing a light to illuminate a space, the apparatus adapted to be vertically mounted on a ceiling and facing a floor below the ceiling, the apparatus being surrounded by walls with one or more windows, the apparatus comprising:
a supporting base, with mechanical support to a base and electrical connections to an electrical energy source,
a supporting surface mounted on the supporting base such that the supporting surface is capable to provide physical support and electrical connections for a plurality of LED chips which is capable of emitting light, wherein,
the supporting surface mounted on the supporting base has a preferred shape and is at a preferred location and at a preferred orientation, such that the shape, location and orientation of the supporting surface causes that each LED chip of the plurality of LED chips is at a preferred position in the space, and faces a preferred direction in the space, wherein,
the light emitted by the plurality of the LED chips is directed either to the ceiling or to the walls surrounding the ceiling, while not directed to the floor below the ceiling,
the supporting surface being of such a shape as to promote the spread of the light emitted by the LED chips among the ceiling and among the walls surrounding the ceiling,
the light emitted by at least one of the plurality of the LED chips is along the propagation path from the emission of the light until its first scattering event, wherein,
the light emitted by at least one of the plurality of the LED chips is confined to one path from the set:
1) light paths such that the initial light beam after emission and before a first scattering event propagates at heights higher than 5 feet 5 inches,
2) propagates at angular orientation such that no light beam crosses from above the height of 5 feet wherein,
the shape of the supporting surface that provides physical support for at least one of the plurality of the LED chips is such that the LED chips at the supporting surface emit light in a direction that is determined by the shape of the supporting surface, wherein,
the LED chips emit light with a divergence angle smaller than 90 degrees.

10. The apparatus for producing the light to illuminate the space according to claim 9, further provided with a louver at such a location and direction as to further block the paths of the light produced by at least one of the plurality of the LED chips to propagate below 5 feet.

11. The apparatus for producing the light to illuminate the space according to claim 9, wherein the support structure further supports a louver at such a location and direction as to further block the paths of the light produced by at least one of the plurality of the the LED chips to propagate below 5 feet.

12. The apparatus for producing the light to illuminate the space according to claim 9, wherein the base support and the supporting surface are combined in a single entity.

13. (canceled)

14. (canceled)

15. The apparatus according to claim 9, wherein the supporting surface is concave.

16. The apparatus according to claim 9, wherein the supporting surface is convex.

17. (canceled)

18. (canceled)
